(19) United States
(12) Patent Application Publication
(10) Pub. No.: US 2025/0038917 A1
(43) Pub. Date: Jan. 30, 2025

(54) Sounding Reference Signal Transmission in a Wireless Communication Network

(71) Applicant: Telefonaktiebolaget LM Ericsson (publ), Stockholm (SE)

(72) Inventors: Sairamesh Nammi, Austin, TX (US); Namir Lidian, Solna (SE)

(21) Appl. No.: 18/716,293

(22) PCT Filed: Dec. 6, 2021
(86) PCT No.: PCT/EP2021/084315

§ 371 Date: Jun. 4, 2024

(51) Int. Cl. H04L 5/00

(52) U.S. Cl. CPC H04L 5/0051; H04L 5/0064

(57) ABSTRACT

A wireless communication device (12) is configured for use in a wireless communication network (10). The wireless communication device (12) obtains a value of a metric (22) that indicates a speed at which the wireless communication device (12) moves. The wireless communication device (12) determines, based on the value of the metric (22), an indication (15) that indicates a recommendation of how often the wireless communication device (12) is to send the SRS (18) and/or of whether the wireless communication device (12) is to send the SRS (18) periodically or aperiodically. The wireless communication device (12) transmits the indication (15) to a network node (14) in the wireless communication network (10). The network node (14) determines, taking into account the indicated recommendation, how often the wireless communication device (12) is to send the SRS (18) and/or whether the wireless communication device (12) is to send the SRS (18) periodically or aperiodically.

### TECHNICAL FIELD

The present application relates generally to a wireless communication network, and relates more particularly to sounding reference signal transmission in such a network.

### BACKGROUND

A wireless communication device in a wireless communication network sends a sounding reference signal (SRS) over a wide frequency bandwidth, e.g., over the full system bandwidth or bandwidth of interest. The SRS may for example be a wideband signal sent over the wide frequency bandwidth, or may be a narrowband signal frequency hopped across the wide frequency bandwidth. Regardless, the network uses the received SRS to estimate the radio channel over the wide bandwidth and to correspondingly determine which frequency resources within that wide frequency bandwidth to allocate to the wireless communication device for control and data transmission. The device then performs its control and data transmissions within the assigned frequency resources. The device may also send a reference signal, such as a demodulation reference signal (DMRS), within the assigned frequency resources, to assist the network with coherent demodulation.

The network can configure a wireless communication device to send SRS periodically, to provide periodic opportunities for channel sounding. The network can even adapt the period for SRS, e.g., to be as short as 2 ms or as long as 320 ms. A shorter period means the SRS is sent more often, whereas a longer period means SRS is sent less often. According to known approaches, then, the network can configure fast moving devices to send SRS more frequently, for channel sounding on a shorter timescale, but configure slow moving devices to send SRS less frequently, for channel sounding on a longer timescale.

Challenges exist, though, in that more frequent SRS transmission consumes meaningful radio resources and correspondingly jeopardizes system throughput in the uplink. This proves especially true as channel sounding on a shorter timescale becomes more and more important, e.g., in the context of high carrier frequencies (e.g., 3 GHz or higher), low latency services, and/or highly beamformed communications, such as in reciprocity-based massive multiple-input multiple-output (MIMO) systems.

### SUMMARY

It may be an object of the invention herein to provide measures with which throughput in the uplink can be increased while still sounding the channel often enough for moving devices.

According to some embodiments herein, a method performed by a wireless communication device configured for use in a wireless communication network. The method comprises obtaining a value of a metric that indicates a speed at which the wireless communication device moves. The method further comprises determining, based on the value of the metric, an indication that indicates a recommendation of how often the wireless communication device is to send the SRS and/or of whether the wireless communication device is to send the SRS periodically or aperiodically. The method further comprises transmitting the indication to a network node in the wireless communication network.

In some embodiments, the indicated recommendation recommends that the wireless communication device is to send the SRS more often for values of the metric below a threshold as compared to for values of the metric above the threshold. In embodiment, for example, the threshold is an upper threshold, a lower threshold is lower than the upper threshold, and the indicated recommendation recommends that the wireless communication device is to send the SRS more often for values of the metric between the lower threshold and the upper threshold as compared to for values of the metric above the upper threshold. The indicated recommendation may for instance recommend that the wireless communication device is to send the SRS more often for values of the metric below the lower threshold as compared to for values of the metric above the upper threshold. Alternatively or additionally, the indicated recommendation may recommend that the wireless communication device is to send the SRS more often for values of the metric between the lower threshold and the upper threshold as compared to for values of the metric below the lower threshold.

In some embodiments, if the value of the metric is below a threshold, the indicated recommendation recommends that the wireless communication device is to send the SRS aperiodically and, if the value of the metric is above the threshold, the indicated recommendation recommends that the wireless communication device is to send the SRS periodically.

In some embodiments, if the value of the metric is between a=lower threshold and an upper threshold, the indicated recommendation recommends that the wireless communication device is to send the SRS aperiodically. And, if the value of the metric is below the lower threshold or above the upper threshold, the indicated recommendation recommends that the wireless communication device is to send the SRS periodically.

In some embodiments, the metric is a Doppler metric equal to v*f_{c}/C, where v is the speed of the wireless communication device, f_{c} is an uplink carrier frequency of the wireless communication device, and C is the speed of light in free space.

In some embodiments, the metric is the speed of the wireless communication device.

In some embodiments, the method further comprises receiving, from the network node, signaling that configures or triggers the wireless communication device to send the SRS taking into account the indicated recommendation. The method may also comprise transmitting the SRS from the wireless communication device according to the received signaling.

In some embodiments, determining the indication is based also on a power headroom of the wireless communication device.

In some embodiments, determining the indication is based also on a remaining battery life of the wireless communication device.

Embodiments herein also include a method performed by a network node configured for use in a wireless communication network. The method comprises receiving, from a wireless communication device, an indication that indicates a recommendation of how often the wireless communication device is to send the SRS and/or of whether the wireless communication device is to send the SRS periodically or aperiodically. The method also comprises determining, taking into account the indicated recommendation, how often the wireless communication device is to send the SRS and/or whether the wireless communication device is to send the SRS periodically or aperiodically. The method further comprises transmitting, to the wireless communication device, signaling that configures or triggers the wireless communication device to send the SRS as determined.

In some embodiments, said determining also takes into account a load of the network node and/or a load of a cell serving the wireless communication device.

In some embodiments, the method further comprises receiving the SRS from the wireless communication device. In one such embodiment, the method also comprises performing channel estimation for the wireless communication device based on the SRS received from the wireless communication device, and transmitting a downlink data transmission to the wireless communication device, and/or receiving an uplink data transmission from the wireless communication device, based on the performed channel estimation. In this case, the downlink data transmission may be performed according to time division duplexing (TDD) operation and/or transmitting the downlink data transmission to the wireless communication device based on the performed channel estimation may comprise precoding the downlink data channel transmission based on the performed channel estimation.

Embodiments herein also include corresponding apparatus, computer programs, and carriers of those computer programs. For example, embodiments herein also include a wireless communication device configured for use in a wireless communication network. The wireless communication device is configured, e.g., via communication circuitry and processing circuitry, to obtain a value of a metric that indicates a speed at which the wireless communication device moves. The wireless communication device is also configured to determine, based on the value of the metric, an indication that indicates a recommendation of how often the wireless communication device is to send the SRS and/or of whether the wireless communication device is to send the SRS periodically or aperiodically. The wireless communication device is further configured to transmit the indication to a network node in the wireless communication network.

Embodiments herein further include a network node configured for use in a wireless communication network. The network node is configured, e.g., via communication circuitry and processing circuitry, to receive, from a wireless communication device, an indication that indicates a recommendation of how often the wireless communication device is to send the SRS and/or of whether the wireless communication device is to send the SRS periodically or aperiodically. The network node is also configured to determine, taking into account the indicated recommendation, how often the wireless communication device is to send the SRS and/or whether the wireless communication device is to send the SRS periodically or aperiodically. The network node is further configured to transmit, to the wireless communication device, signaling that configures or triggers the wireless communication device to send the SRS as determined.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a wireless communication network according to some embodiments.

FIG. 2A is a block diagram of a relation between at least one value of a metric and at least one SRS period according to some embodiments.

FIG. 2B is a block diagram of a relation between at least one value of a metric and at least one SRS triggering interval according to some embodiments.

FIG. 3A is a block diagram of a relation between different values of a metric and different SRS periods according to some embodiments.

FIG. 3B is a block diagram of a relation between different values of a metric and different SRS periods according to other embodiments.

FIG. 4A is a block diagram of rule(s) according to which a wireless communication device determines a recommendation for SRS according to some embodiments.

FIG. 4B is a block diagram of rule(s) according to which a wireless communication device determines a recommendation for SRS according to other embodiments.

FIG. 5A is a graph of link throughput for device speed of 3 Kmph according to some embodiments.

FIG. 5B is a graph of link throughput for device speed of 10 Kmph according to some embodiments.

FIG. 5C is a graph of link throughput for device speed of 30 Kmph according to some embodiments.

FIG. 5D is a graph of link throughput for device speed of 120 Kmph according to some embodiments.

FIG. 6A is a graph of link throughput achievable according to some embodiments herein.

FIG. 6B is a graph of link throughput achievable according to conventional approaches.

FIG. 7A is a graph of a user throughput cumulative distribution function (CDF) with 5 slot SRS periodicity according to some embodiments.

FIG. 7B is a graph of a user throughput cumulative distribution function (CDF) with 1 slot SRS periodicity according to some embodiments.

FIG. 8 is a graph of the average sector throughput improvement according to some embodiments.

FIG. 9 is a message sequence diagram for embodiments where the wireless communication network is a reciprocity-based MIMO network.

FIG. 10A is a logic flow diagram of a method performed by a wireless communication device according to some embodiments.

FIG. 10B is a logic flow diagram of a method performed by a network node according to some embodiments.

FIG. 11A is a block diagram of a wireless communication device according to some embodiments.

FIG. 11B is a block diagram of a network node according to some embodiments.

FIG. 12 is a block diagram of a wireless communication network, in the form of a communication system, in accordance with some embodiments.

FIG. 13 is a block diagram of a user equipment according to some embodiments.

FIG. 14 is a block diagram of a network node according to some embodiments.

FIG. 15 is a block diagram of a host according to some embodiments.

FIG. 16 is a block diagram illustrating a virtualization environment in which functions implemented by some embodiments may be virtualized.

FIG. 17 is a block diagram of a host communicating via a network node with a UE over a partially wireless connection in accordance with some embodiments.

### DETAILED DESCRIPTION

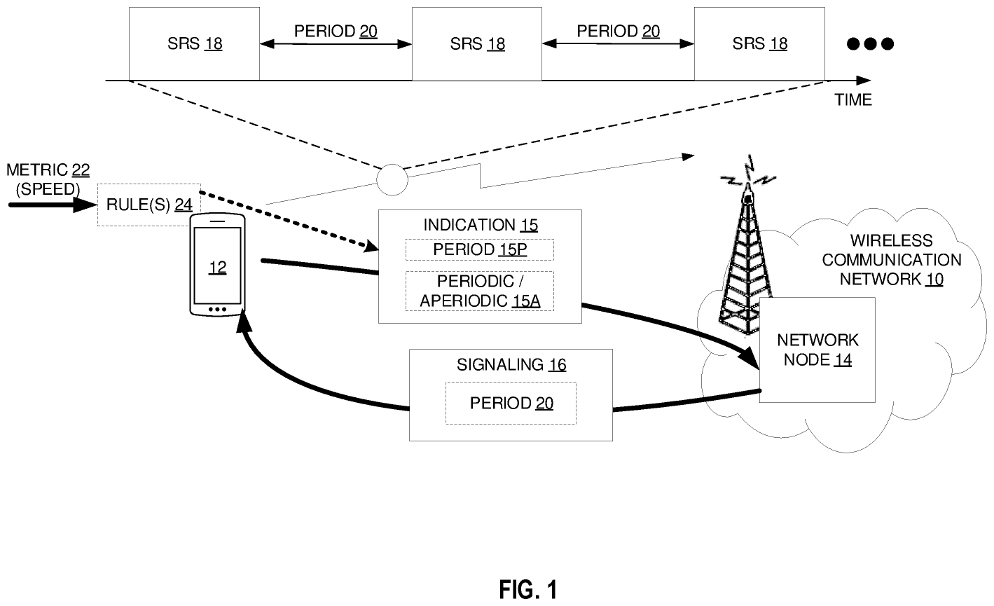

FIG. 1 shows a wireless communication network 10 configured to provide wireless communication service to a wireless communication device 12 according to some embodiments. The wireless communication device 12 may send a sounding reference signal (SRS) 18 to the wireless communication network 10, in order to sound the uplink channel. The wireless communication device 12 may for example send the SRS 18 over a wide frequency bandwidth, e.g., over the full system bandwidth or bandwidth of interest. The SRS 18 may for example be a wideband signal sent over a wide frequency bandwidth, or may be a narrowband signal frequency hopped across the wide frequency bandwidth. The more often the wireless communication device 12 sends the SRS 18, the more often the channel can be estimated from that SRS 18, but the more radio resources that SRS 18 consumes.

The wireless communication network 10 accordingly includes a network node 14 that determines how often the wireless communication device 12 is to send the SRS 18. Based on this determination, the network node 14 transmits signaling 16 to the wireless communication device 12, e.g., Radio Resource Control (RRC) signaling, Medium Access Control (MAC) signaling, and/or downlink control information (DCI) signaling. The signaling 16 configures or triggers the wireless communication device 12 to send the SRS 18 as often as determined.

For example, in periodic SRS transmission embodiments, the signaling 16 may configure the wireless communication device 12 to send the SRS 18 periodically in time. The signaling 16 in this case may indicate how often the wireless communication device 12 is to send the SRS 18 by indicating a period 20 with which the SRS 18 is to be periodically sent by the wireless communication device 12, i.e., without the wireless communication device 12 having to receive any further signaling. This period 20 may also be referred to as the SRS period or SRS periodicity, where lower SRS periodicity corresponds to a relatively shorter period 20 between recurrences of the SRS 18 and higher SRS periodicity corresponds to a relatively longer period 20 between recurrences of the SRS 18. In these embodiments, then, the network node 14 may configure the wireless communication device 12 to send the SRS 18 more or less often by sending signaling 16 that indicates a shorter or longer period 20, respectively.

In aperiodic SRS transmission embodiments, by contrast, the signaling 16 may trigger the wireless communication device 12 to send the SRS 18 just once, i.e., in an aperiodic or single-shot fashion. In one or more of these embodiments, the signaling 16 for triggering the wireless communication device 12 to send the SRS 18 may be MAC signaling or DCI signaling, and/or may comprise a positive SRS request that requests the wireless communication device 12 to send the SRS 18. Triggering the wireless communication device 12 to send SRS 18 in this way may provide greater flexibility as to whether and/or when the wireless communication device 12 is to send an SRS 18, e.g., the network node 14 may not trigger the wireless communication device 12 to send an SRS when the wireless communication device 12 does not have any uplink data to transmit. Regardless, in these embodiments, the network node 18 may transmit the signaling 16 to the wireless communication device 12 as often as the wireless communication device 12 is to send the SRS 18. The network node 14 may thereby trigger the wireless communication device 12 to send the SRS 18 more or less often by sending signaling 16 more or less often, respectively.

No matter the particular nature of the signaling 16, though, the wireless communication device 12 according to embodiments herein transmits an indication 15 to the network node 14, to assist the network node 14 with its determination of how often the wireless communication device 12 is to send the SRS 18. The indication 15 may for example indicate a recommendation of how often the wireless communication device 12 is to send the SRS 18, e.g., by indicating a preference for how often the wireless communication device 12 is to send the SRS 18. The indication 15 may do so by indicating a recommendation of a period 15P with which the SRS 18 is to be periodically sent by the wireless communication device 12, or by indicating a recommendation of an interval between times at which the network node 14 is to trigger the wireless communication device 12 to transmit SRS 18 aperiodically. In embodiments where the wireless communication device 12 recommends an SRS period 15P, the network node 14 may take this recommended period 15P into account (e.g., along with one or more other network-side decision factors such as cell load) when deciding on the actual period 20 with which to configure the wireless communication device 12.

Alternatively or additionally, the indication 15 may indicate a recommendation of whether the wireless communication device 12 is to send the SRS 18 periodically or aperiodically, e.g., by indicating a preference for whether the wireless communication device 12 is to send the SRS 18 periodically or aperiodically. The indication 15 in this case may for instance indicate (e.g., with a flag or bit) whether the wireless communication device 12 prefers to send the SRS 18 periodically or aperiodically 15A The network node 14 may similarly take this preference into account (e.g., along with one or more other network-side decision factors such as cell load) when deciding on whether to configure the wireless communication device 12 to send the SRS 18 periodically or aperiodically.

In these or other embodiments, then, the indication 15 may generally indicate one or more preferred values for one or more parameters that govern SRS transmission by the wireless communication device 12. For example, the indication 16 may indicate a preferred value for an SRS period 15P, a preferred value for an SRS triggering interval, and/or a preferred value for a parameter governing whether SRS transmission is to occur periodically or aperiodically.

By providing such an indication 15 from the wireless communication device 12, embodiments herein give the wireless communication device 12 some input into the network node's decision about how often the wireless communication device 12 is to transmit SRS 18. If the wireless communication device 12 forms its indication 15 based on factors or parameters local to the wireless communication device 12, then, the network node's decision will effectively account for such factors or parameters, even without the wireless communication device 12 having to signal each of those factors or parameters to the network node 14. Some embodiments thereby advantageously provide network-side control of how often the wireless communication device 12 is to transmit SRS 18 in a way that still accounts for device-side factors and/or preferences, e.g., while also minimizing the signaling needed to do so.

In some embodiments, the local factors or parameters based on which the wireless communication device 12 forms the indication 15 account for a speed at which the wireless communication device 12 moves. FIG. 1 for example shows that the wireless communication device 12 may determine the indication 15 based on the value of a metric 22 that indicates a speed at which the wireless communication device 12 moves. In particular, FIG. 1 shows that the wireless communication device 12 determines the indication 15 according to one or more rules 24 specified as a function the value of the metric 22 for the wireless communication device 12. The rule(s) 24 may for instance specify, as a function of the value of the metric 22, (i) the period 15P to recommend for transmitting SRS 18; and/or (ii) indication of whether the wireless communication device 12 is to transmit SRS 18 periodically or aperiodically.

In one embodiment, the metric 22 may be the speed of the wireless communication device 12 itself, so as to directly indicate the device's speed. In other embodiments, the metric 22 indirectly indicates the speed of the wireless communication device 12. For example, the metric 22 may be proportional to the speed of the wireless communication device 12. The metric 22 may for instance be a Doppler metric equal to v*f_{c}/C, where v is the speed of the wireless communication device 12, f_{c} is an uplink carrier frequency of the wireless communication device 12, and C is the speed of light in free space. In these and other embodiments, higher values of the metric 22 indicate the wireless communication device 12 is moving faster and/or has a shorter channel coherence time.

The wireless communication device 12 may obtain the value of the metric 22 in any number of ways. For example, the wireless communication device 12 may compare the difference between channel quality indicator (CQI) indices reported by the wireless communication device 12 in two consecutive time intervals, and deduce the value of the metric 22 from the rate of change of CQI indices. Or, the wireless communication device 12 may determine the value of the metric 22 by computing the direct speed of the device 12, e.g., by positioning or Global Positioning System (GPS) at multiple intervals. In this case, where the metric 22 is Doppler metric, for example, the value of the metric 22 may be computed as the average of individual speed measurements. As yet another example, the wireless communication device 12 may coarsely measure its speed, e.g., by determining whether the device is moving with slow, medium, or high speed. In another example, the wireless communication device 12 may estimate the downlink channel from a Demodulation Reference Signal (DMRS), and determine a measure of the Doppler metric as the rate of change of the downlink channel.

No matter the particular nature of the metric 22, higher values of the metric 22 generally suggest that the wireless communication device 12 should send the SRS 18 more often in time, to provide channel sounding on a shorter timescale that accounts for the device's shorter channel coherence time. Notably, though, according to embodiments herein, the wireless communication device 12 recommends sending the SRS 18 more often for at least one value of the metric 22 below a threshold as compared to for at least one value above the threshold. The rule(s) 24 according to which the wireless communication device 12 determines the indication 15 may correspondingly dictate that the wireless communication device 12 is to recommend sending the SRS 18 more often for at least one value of the metric 22 below a threshold as compared to for at least one value above the threshold.

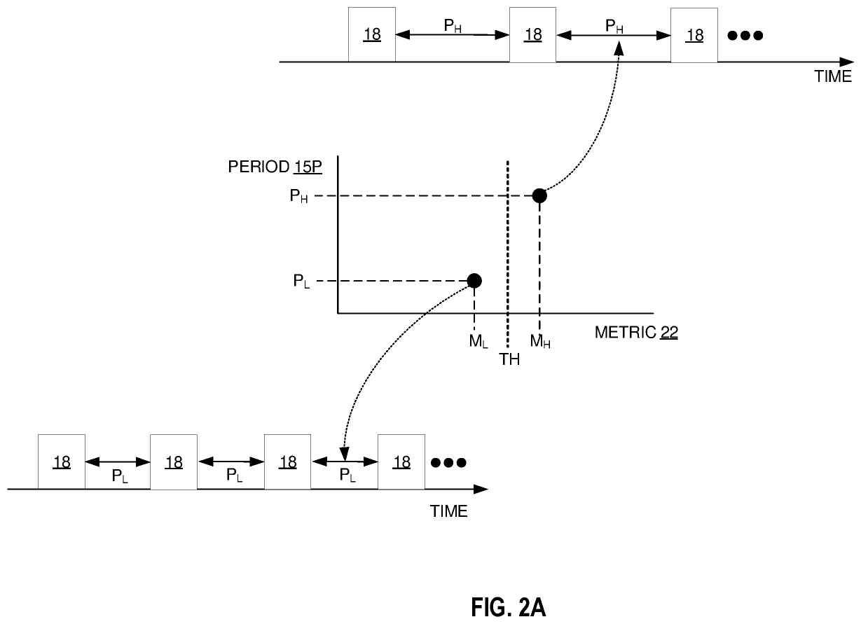

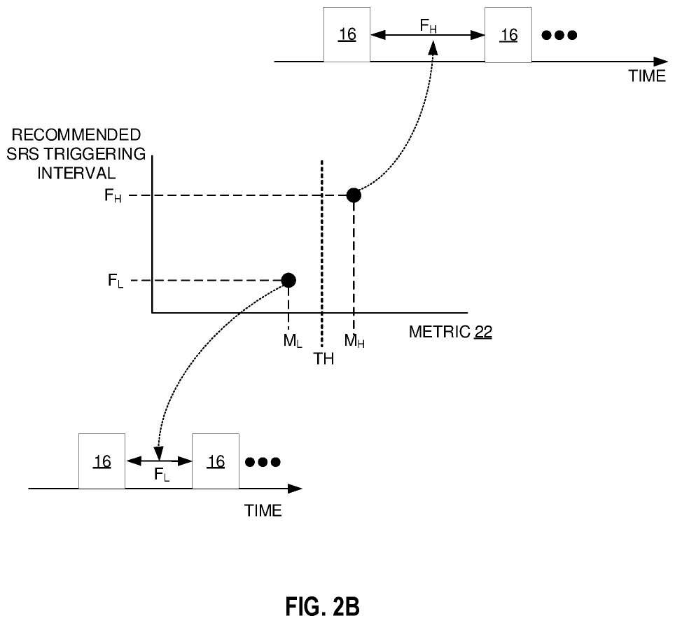

FIG. 2A illustrates one example graphically for periodic SRS transmission embodiments where the indication 15 recommends a period 15P according to which the wireless communication device 12 is to send the SRS 18. As shown, the wireless communication device 12 recommends periodically sending the SRS 18 with a period P_{H} for a value M_{H} of the metric 22 above a threshold TH, whereas the wireless communication device 12 recommends periodically sending the SRS 18 with a period P_{L} for a value M_{L} of the metric 22 below the threshold TH. With period P_{L} smaller than period P_{H}, this means that the wireless communication device 12 recommends sending the SRS 18 more often in time for value M_{L} of the metric 22 (below the threshold TH) as compared to for value M_{H} of the metric 22 (above the threshold TH).

According to some embodiments herein, therefore, the wireless communication device 12 does not unconditionally decrease the period 15P recommended for the SRS 18 with increasing values of the metric 22. That is, a higher value for the metric 22 (e.g., faster device speed) does not always or necessarily mean recommending a shorter period 15P. In some embodiments, that may generally be the case, but only for values of the metric 22 below the threshold. Indeed, for values of the metric 22 below the threshold, the period 15P recommended may monotonically decrease with increasing values of the metric 22, but, for at least some value(s) of the metric 22 above the threshold, the period 15P recommended may be longer than for at least some value(s) of the metric 22 below the threshold. Correspondingly, for at least some value(s) of the metric 22 below the threshold, the period 15P recommended may be shorter than for at least some value(s) of the metric 22 above the threshold.

FIG. 2B illustrates another example graphically for aperiodic SRS transmission embodiments where the signaling 16 from the network node 14 triggers the wireless communication device 12 is to send the SRS 18, e.g., in a one-shot or aperiodic fashion. In this case, the network node 14 transmits the signaling 16 as often as the wireless communication device 12 is to send the SRS 18, such that the (potentially aperiodic) interval between the times at which the network node 14 transmits the signaling 16 governs how often the wireless communication device 12 sends the SRS 18. As shown in FIG. 2B, the recommended interval between times at which the network node 14 transmits the signaling 16 is referred to as the recommended SRS triggering interval. The wireless communication device 12 in this example recommends an SRS triggering interval of F_{H} for a value M_{H} of the metric 22 above a threshold TH, whereas the wireless communication device 12 recommends an SRS triggering interval of F_{L} for a value M_{L} of the metric 22 below the threshold TH. With interval F_{L} smaller than interval F_{H}, this means that the recommended SRS triggering interval is smaller for value M_{L} of the metric 22 as compared to for value M_{H} of the metric 22. Over the course of this time, then, the wireless communication device 12 recommends that the network node 14 trigger the wireless communication device 12 to send the SRS 18 more often in time for value M_{L} of the metric 22 (below the threshold TH) as compared to for value M_{H} of the metric 22 (above the threshold TH).

According to some embodiments herein, therefore, the wireless communication device 12 does not unconditionally decrease the SRS triggering interval that it recommends with increasing values of the metric 22. That is, a higher value for the metric 22 (e.g., faster device speed) does not always or necessarily mean that the wireless communication device 12 recommends a shorter interval at which the network node 14 is to trigger the wireless communication device 12 to send the SRS 18. In some embodiments, that may generally be the case, but only for values of the metric 22 below the threshold. Indeed, for values of the metric 22 below the threshold, the recommended SRS triggering interval may monotonically decrease with increasing values of the metric 22, but, for at least some value(s) of the metric 22 above the threshold, the recommended SRS triggering interval may be longer than for at least some value(s) of the metric 22 below the threshold. Correspondingly, for at least some value(s) of the metric 22 below the threshold, the recommended SRS triggering interval may be shorter than for at least some value(s) of the metric 22 above the threshold.

According to some embodiments, the wireless communication device 12 recommends that the network node 14 trigger the wireless communication device 12 to send SRS 18 in this way based on a strategy of generally sending SRS 18 more often for increasing values of the metric 22, but only up to a point represented by the threshold, e.g., in recognition that more frequent SRS 18 would not yield meaningfully improved performance for values of the metric 22 above the threshold. Accordingly, rather than recommending that the network node 14 configure or trigger the wireless communication device 12 to send SRS 18 even more often for values of the metric 22 above the threshold, with no or only marginal performance improvement, some embodiments recommend that the network node 14 configure or trigger the wireless communication device 12 to send SRS 18 less often for such metric values, in favor of preserving radio resources.

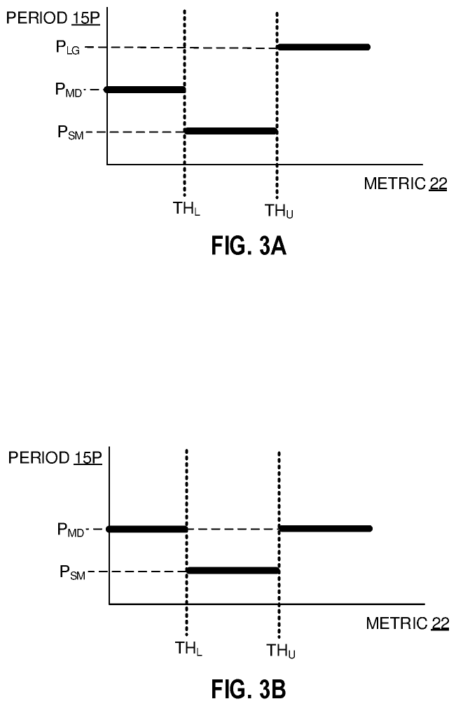

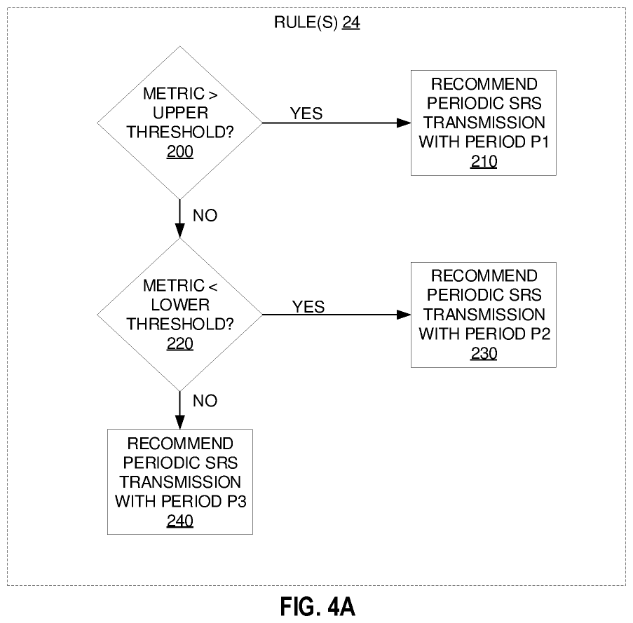

FIG. 3A illustrates one example where the threshold takes the form of an upper threshold TH_{U}. As shown, for any value of the metric 22 below a lower threshold TH_{L}, the wireless communication device 12 recommends that it is to send SRS 18 with a medium period P_{MD} e.g., P_{MD}=5 or 10 slots. The lower threshold TH_{L} may, for instance, correspond to a wireless communication device moving with a speed of 3 Kmph or 10 Kmph. For any value of the metric 22 between the lower threshold TH_{L} and an upper threshold TH_{U}, the wireless communication device 12 recommends that it is to send SRS 18 with a small period P_{SM} that is smaller/shorter than the medium period P_{MD}, e.g., P_{LG}=100 or 1000 slot. The upper threshold TH_{U} may, for instance, correspond to a wireless communication device moving with a speed of 120 Kmph. For values of the metric 22 below the upper threshold TH_{U}, then, the wireless communication device 12 generally recommends that it is to send SRS 18 more often as the value of the metric 22 increases, e.g., to track the channel on a shorter timescale as the device speed increases and the channel coherence time decreases. Notably, though, as shown in FIG. 3A, for any value of the metric 22 above the upper threshold TH_{U}, the wireless communication device 12 recommends that it is to send SRS 18 with a large period P_{U} that is larger/longer than both the small period P_{SM} and the medium period P_{MD}, e.g., P_{LG}=100 or 1000 slots. That is, rather than recommending that the wireless communication device 12 is to send the SRS 18 more often due to the metric exceeding the upper threshold TH_{U}, the wireless communication device 12 actually recommends that it is to send the SRS 18 less often. Indeed, for any of the values of the metric 22 above the upper threshold TH_{U}, the wireless communication device 12 recommends that it is to send SRS 18 less often than for any of the values of the metric 22 below the upper threshold TH_{U}. According to this example, then, the wireless communication device 12 recommends that it is to send the SRS 18 more often for all values of the metric 22 below the upper threshold TH_{U} as compared to for any of the values of the metric 22 above the upper threshold TH_{U}.

FIG. 3B illustrates another example. Similar to FIG. 3A, for any value of the metric 22 below a lower threshold TH_{L}, the wireless communication device 12 recommends that it is to send SRS 18 with a medium period P_{MD}. And for any value of the metric 22 between the lower threshold TH_{L} and an upper threshold TH_{U}, the wireless communication device 12 recommends that it is to send SRS 18 with a small period P_{SM} that is smaller/shorter than the medium period P_{MD}. For values of the metric 22 below the upper threshold TH_{U}, then, the wireless communication device 12 generally recommends that it is to send SRS 18 more often as the value of the metric 22 increases. Notably, though, as shown in FIG. 3B, for any value of the metric 22 above the upper threshold TH_{U}, the wireless communication device 12 recommends that it is to send SRS 18 with the medium period P_{MD}. Accordingly, once the value of the metric 22 exceeds the upper threshold TH_{U}, the wireless communication device 12 recommends that it is to send SRS 18 less often as compared to values of the metric 22 between the lower threshold TH_{L} and the upper threshold TH_{U}. According to this example, then, the wireless communication device 12 recommends that it is to send the SRS 18 more often for some values of the metric 22 below the upper threshold TH_{U} (namely, those values between the lower threshold TH_{L} and the upper threshold TH_{U}) as compared to for any of the values of the metric 22 above the upper threshold TH_{U}.

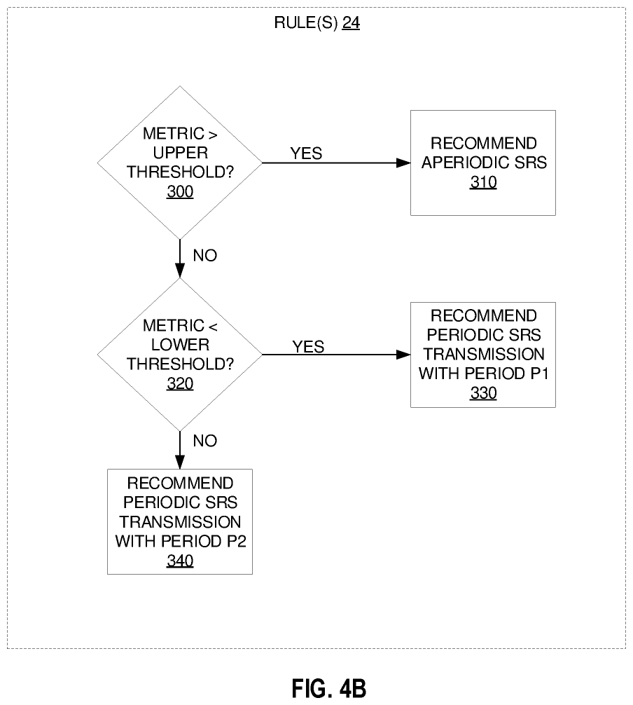

FIG. 4A shows one example of how the rule(s) 24 for determining the recommendation 15 may be specified in some embodiments. As shown, the rule(s) 24 dictate that, for any value of the metric 22 above the upper threshold (YES at Block 200), the indication 15 indicates a recommendation that the wireless communication device 12 is to send the SRS 18 periodically with a first period P1 (Block 210). For any value of the metric 22 below the lower threshold (YES at Block 220), the indication 15 indicates a recommendation that the wireless communication device 12 is to send the SRS 18 periodically with a second period P2 (Block 230). And, for any value of the metric 22 between the lower threshold and the upper threshold (NO at Block 220), the indication 15 indicates a recommendation that the wireless communication device 12 is to send the SRS 18 periodically with a third period P3 (Block 240).

In some embodiments, the first period P1 is larger than the second period P2 and the third period P3, and the second period P2 is larger than the third period P3. In the example of FIG. 3A, for instance, the first period P1 is the large period P_{LG}, the second period P2 is the medium period P_{MD}, and the third period P3 is the small period P_{SM}, where the large period P_{LG} is larger than the medium period P_{MD} and the small period P_{SM}, and the medium period P_{MD} is larger than the small period P_{SM}.

In other embodiments, the first period P1 is larger than the third period P3. In the example of FIG. 3B, for instance, the first period P1 is the medium period P_{MD}, the second period P2 is also the medium period P_{MD}, and the third period P3 is the small period P_{SM}, where the medium period P_{MD} is larger than the small period P_{SM}.

FIG. 4B shows an example of how the rule(s) 24 may be specified in yet other embodiments. As shown, the rule(s) 24 dictate that, for any value of the metric 22 above the upper threshold (YES at Block 300), the indication 15 indicates a recommendation that the wireless communication device 12 is to send SRS 18 aperiodically (Block 310). In this case, then, the indication 15 indicates a recommendation that the network node 14 is to transmit the signaling 16 to the wireless communication device 12 as often as the wireless communication device 12 is to send the SRS 18, i.e., the signaling 16 triggers the wireless communication device 12 to send the SRS 18 once each time the signaling 16 is transmitted/received. By contrast, for any value of the metric 22 below the upper threshold, (NO at Block 300), the indication 15 indicates a recommendation that the wireless communication device 12 is to send the SRS 18 periodically. In particular, for any value of the metric 22 below the lower threshold (YES at Block 320), the indication 15 indicates a recommendation that the wireless communication device 12 is to send the SRS 18 periodically with a first period P1 (Block 330). And, for any value of the metric 22 between the lower threshold and the upper threshold (NO at Block 320), the indication 15 indicates a recommendation that the wireless communication device 12 is to send the SRS 18 periodically with a second period P2 (Block 340). In some embodiments, the first period P1 is larger than the second period P2.

Note here that the labels “period P1” and “period P2” in FIG. 4B are re-used from FIG. 4A, but do not imply any relationship to the periods in FIG. 4A.

These and other embodiments herein may advantageously provide improved performance, especially in cases that exploit channel sounding on a shorter timescale. This may be the case, for instance, in the context of high carrier frequencies (e.g., 3 GHz or higher), low latency services, and/or highly beamformed communications, such as in reciprocity-based massive multiple-input multiple-output (MIMO) systems.

More particularly in this regard, rather than recommending that the network node 14 configure or trigger wireless communication devices to send SRS even more often for values of the metric 22 above a threshold, with no or only marginal improvement in channel estimation, some embodiments recommend that the network node 14 configure or trigger wireless communication devices to send SRS less often for such metric values, in favor of preserving radio resources. The radio resources that would have otherwise been consumed by SRS can therefore be used for other purposes, e.g., for uplink data transmission, resulting in improved uplink data throughput.

Furthermore, for values of the metric 22 below the threshold, the wireless communication device 12 in some embodiments recommends that the network node 14 configures or triggers the wireless communication device 12 to send the SRS 18 frequently enough to track the channel for the wireless communication device 12. For values of the metric 22 below the threshold, then, channel estimation may be performed on SRS sent by the wireless communication device 12. For values of the metric 22 above the threshold, though, the wireless communication device 12 recommends that the network node 14 configures or triggers the wireless communication device 12 to send SRS less often than needed to track the channel for the wireless communication device 12, if at all, e.g., on the presumption that it is not possible or practical to send the SRS 18 often enough to track the channel in this case. For values of the metric 22 above the threshold, then, channel estimation may or may not be performed on SRS 18, depending on whether or how often the SRS 18 is sent.

If channel estimation is performed on SRS 18, the channel estimation may be exploited for transmission of downlink data to the wireless communication device 12 and/or for reception of uplink data from the wireless communication device 12. For example, with regard to downlink data transmission in embodiments that can assume uplink/downlink reciprocity (e.g., in time division duplex (TDD) operation), some embodiments exploit the channel estimation from SRS for precoding of the downlink data transmission, e.g., for computing the precoding weights. On the other hand, in embodiments where SRS is triggered to be sent less often, or not at all, for values of the metric 22 above the threshold, such that no channel estimation is performed on SRS, codebook-based feedback from the wireless communication device 12 may be used for precoding of downlink data transmissions in lieu of channel estimation.

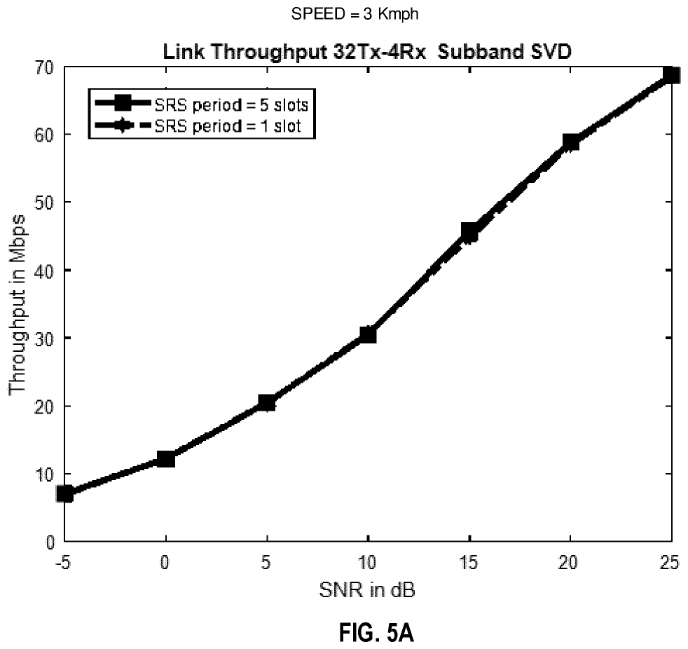

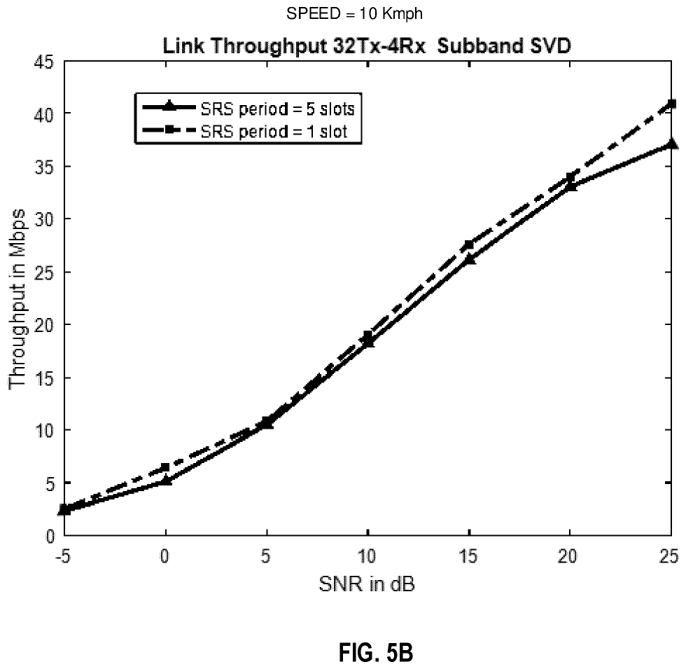

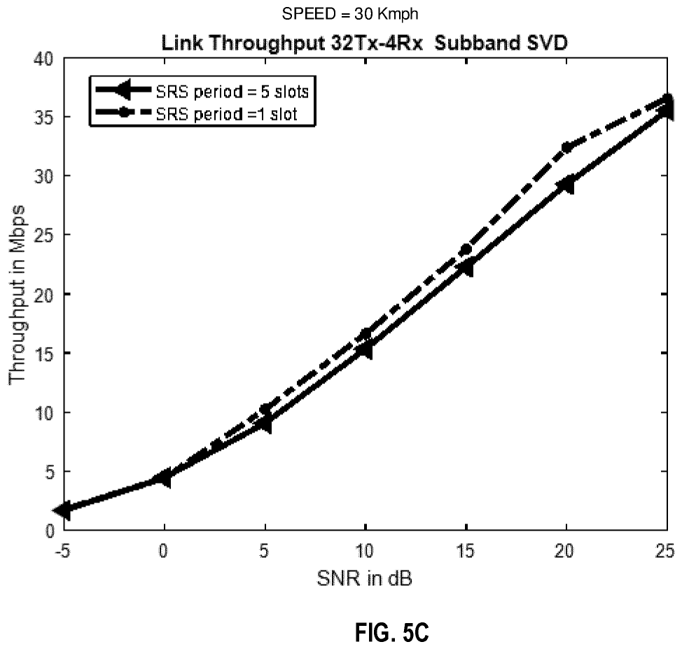

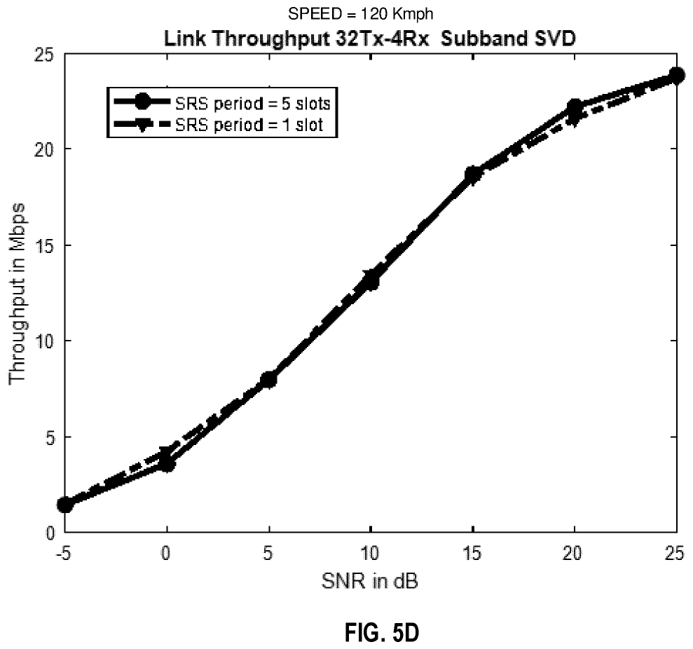

Consider an example in a context where the wireless communication network 10 is a reciprocity-based massive MIMO network, e.g., assuming 32 transmit (TX) antennas and 4 receive (RX) antennas. FIGS. 5A-5D show the achievable link throughput in this case for different device speeds and for different SRS periods, where subband-based singular value decomposition (SVD) is used for finding the precoding weights for downlink data transmission precoding.

As seen in FIG. 5A, for a slow device speed of 3 Kmph, there is not a meaningful difference in link throughput between an SRS period of 1 slot and an SRS period of 5 slots. That is, decreasing the SRS period from 5 slots to 1 slot does not result in a meaningful performance gain. This is because, for such a slow device speed, sending the SRS 18 every 5 slots is sufficient to track the channel (i.e., the channel estimates are not outdated), meaning that recommending that the network node 14 configure or trigger the wireless communication device 12 to send the SRS 18 more often than every 5 slots will not meaningfully improve the channel estimates.

As shown in FIGS. 5B and 5C, by contrast, for medium device speeds of 10 Kmph and 30 Kmph, decreasing the SRS period from 5 slots to 1 slot does result in a meaningful performance gain in terms of link throughput. Indeed, for these moderate device speeds, sending the SRS 18 every 5 slots does not track the channel as well as sending the SRS 18 every 1 slot. That is, recommending that the network node 14 configure or trigger the wireless communication device 12 to send the SRS 18 more often will indeed provide meaningfully improved channel estimates for medium device speeds.

Finally, as shown in FIG. 5D, for fast device speeds of 120 Kmph, decreasing the SRS period from 5 slots to 1 slot does not result in a meaningful performance gain. This is because, for such a fast device speed, neither 5 slot SRS periodicity nor 1 slot SRS periodicity is sufficient to track the channel, meaning that recommending that the network node 14 configure or trigger the wireless communication device 12 to send the SRS 18 more often will not meaningfully improve the channel estimates.

According to FIGS. 5A-5D, therefore, low SRS periodicity on the order of 1 slot is useful only when the device is moving with medium speed, between 10-120 Kmph. Medium SRS periodicity on the order of 5 slots is useful when the device is moving with slow speed, at 3 Kmph. And neither low nor medium SRS periodicity is useful when the device is moving with high speed, at 120 Kmph. FIGS. 5A-5D thereby demonstrate that meaningful performance gains can be realized by decreasing the SRS period as device speed increases, but only up to a point, since decreasing the SRS period further does not result in meaningful performance gains once the device speed reaches a threshold, e.g., 120 Kmph.

In embodiments informed by FIGS. 5A-5D, then, the wireless communication device 12 may obtain the value of the metric 22, e.g., in the form of a Doppler metric or speed for the device 12. The wireless communication device 12 may then determine, based on pre-defined upper and lower thresholds, whether the wireless communication device 12 is a slow speed device, a medium speed device, or a high speed device. The wireless communication device 12 next recommends an SRS periodicity according to that determination.

If the wireless communication device 12 is a slow speed device, the wireless communication device 12 may recommend a medium SRS periodicity (e.g., 5 or 10 slots). If the wireless communication device 12 is a medium speed device, the wireless communication device 12 may recommend a low SRS periodicity (e.g., 1 slot). In one embodiment, if the wireless communication device 12 is a high speed device, the wireless communication device 12 recommends a high SRS periodicity (e.g., 100 or 1000 slots), in which case the SRS periodicity of a medium speed device is always less than the SRS periodicity of a slow speed device and the SRS periodicity of a high speed device is always greater than SRS periodicity of slow and medium speed devices. In another embodiment, if the wireless communication device 12 is a high speed device, the wireless communication device 12 recommends that the network node 14 not trigger the wireless communication device 12 to send any SRS 18 (i.e., completely switch off SRS transmission). Regardless, the wireless communication device 12 transmits the indication 15 to the network node 14 and the network node 14 takes the recommendation indicated by the indication 15 into account in deciding how often the wireless communication device 12 is to send SRS 18. In this regard, the network node 14 may transmits signaling 16 to the wireless communication device 12 that configures or triggers the device 12 to send the SRS 18 as often as determined. For example, if the SRS period is 1 slot, the network node 14 can use a downlink control channel to indicate the SRS periodicity (also called aperiodic SRS reporting), whereas, if the SRS period is greater than 1 slot, the network node 14 can use RRC signaling or a MAC Control Element (CE) for indicating periodic SRS reporting.

In one embodiment, the wireless communication device 12 reports the recommendation 15 as part of an uplink control or shared channel transmission, either periodically or based on request from the network node 14. In another embodiment, the wireless communication device 12 can report the indication 15 implicitly in a shared or control channel transmission, e.g., by using unused fields or combinations of control channel, the wireless communication device 12 can indicate the SRS periodicity.

By recommending SRS periodicities for low and medium speeds that are sufficient for tracking the channel, the wireless communication device 12 recommends SRS periodicities that suffice for sounding the uplink channel frequently enough for the network node 14 to estimate the channel reliably. In reciprocity-based massive MIMO, then, the network node 14 can use the channel estimates from the SRS transmissions to compute precoding weights for downlink data transmission to the wireless communication device 12. If the wireless communication device 12 is a high speed device and is assigned an SRS periodicity, but the SRS periodicity is insufficient for tracking the channel, the network node 14 may not estimate the channel using the SRS 18, or may not use those channel estimates, since the channel is already outdated for precoder computation. If the wireless communication device 12 is a high speed device and is not to send SRS 18 at all, by contrast, the network node 14 may use codebook-based precoding feedback from the device 12 for precoding downlink data transmissions to the device 12.

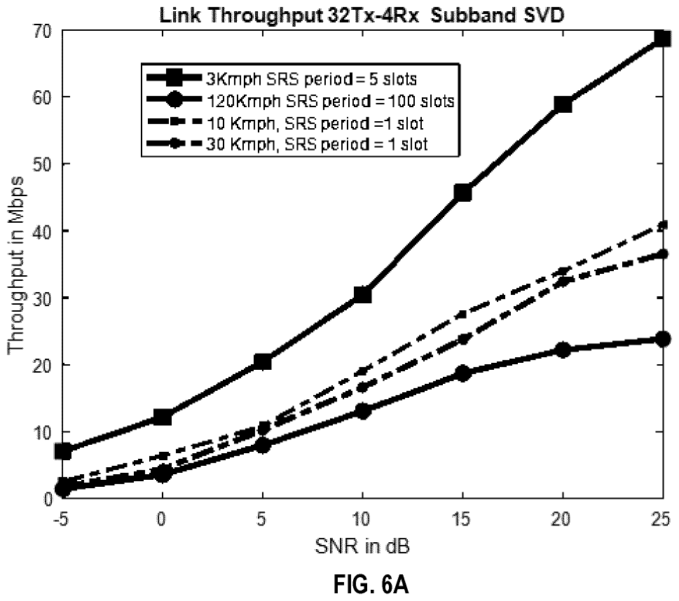

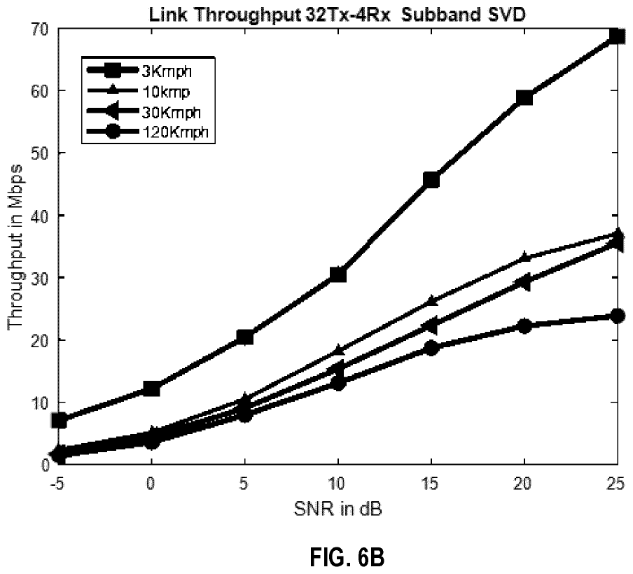

FIG. 6A shows link level performance achievable according to some embodiments. Here, it is assumed that the wireless communication network 10 is a TDD New Radio (NR) massive MIMO system with 32 ports (2 rows and 8 columns advanced antenna system) and with devices capable of receiving 32 ports. Rank information, precoding information, modulation, and coding rate/transport block size are assumed to be dynamically updated for each slot. The precoding matrix is computed by the network node 14 from channel estimates formed from SRS. For link adaptation using Channel State Information (CSI), the device 12 chooses the precoding matrix indicator (PMI), rank indication (RI), and Channel Quality Indicator (CQI) based on maximization of Mutual information. The feedback is assumed to have 4 slots delay and is assumed to be error free. The wireless channel is assumed to be a cluster-delay line (CDL)-A channel. In this context, FIG. 6A shows link throughput achievable for different signal-to-noise ratios (SNRs), where low speed devices (3 Kmph) have an SRS period of 5 slots, medium speed devices (10 Kmph and 30 Kmph) have an SRS period of 1 slot, and high speed devices (120 Kmph) have an SRS period of 100 slots.

By contrast, FIG. 6B shows link level performance achievable using conventional approaches without embodiments herein. As seen by a comparison of FIGS. 6A and 6B, embodiments herein provide performance gains, especially for medium speed devices.

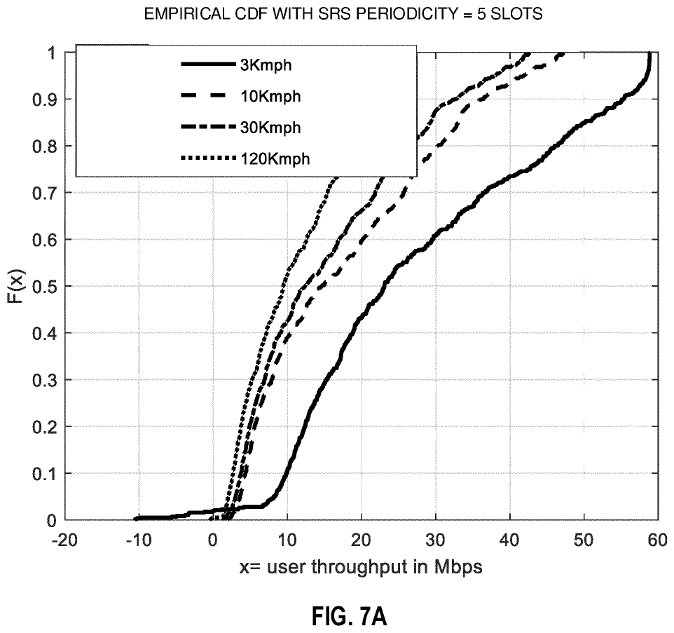

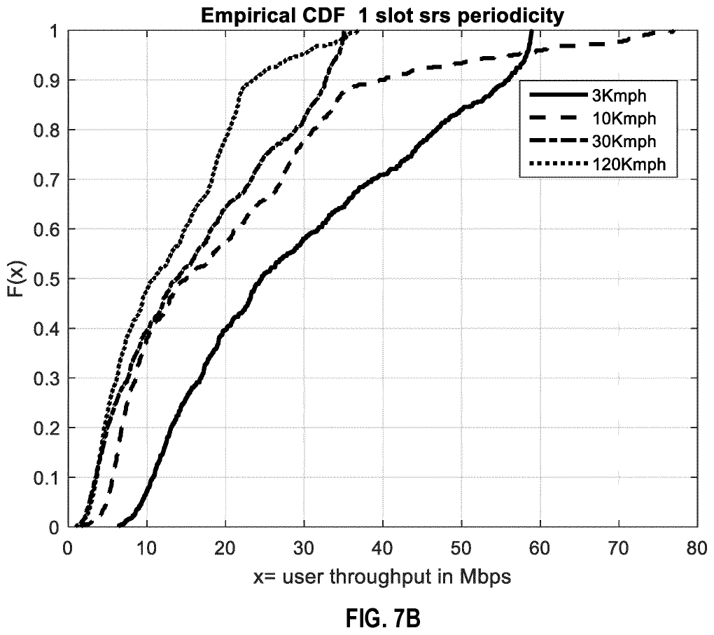

FIGS. 7A-7B show system level performance gains achievable according to some embodiments. FIG. 7A in particular shows the user throughput cumulative distribution function (CDF) with 5 slot SRS periodicity, while FIG. 7B shows the user throughput CDF with 1 slot SRS periodicity. Note here that gains are not realizable even if the channel is sounded frequently for 3 Kmph and 120 Kmph devices.

The table below shows the system throughput with 5 slot and 1 slot periodicities. Codebook-based precoding is shown for comparison purposes as well.

| | | 5 slot SRS | 1 slot SRS | Codebook |
|---|---|---|---|---|
| 3 | Kmph | 27.71 | 28.03 | 20.65 |
| 10 | Kmph | 17.95 | 20.37 | 15.79 |
| 30 | Kmph | 15.66 | 16.14 | 16.91 |
| 120 | Kmph | 10.82 | 10.88 | 11.73 |

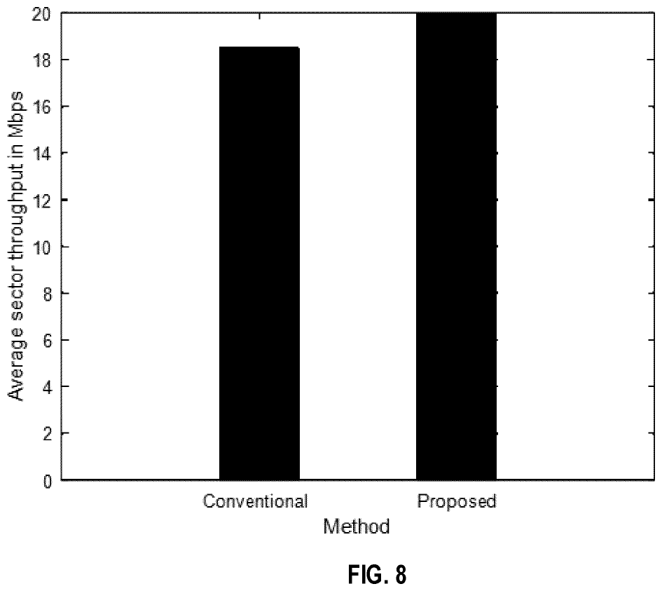

Finally, FIG. 8 shows the average sector throughput improvement according to some embodiments, as compared to conventional approaches with 5 slot SRS periodicity. Here, a mixed device speed scenario is assumed, where a device with 3 Kmph speed occurs with 0.2 probability, a device with 10 Kmph speed occurs with 0.4 probability, a device with 30 Kmph speed occurs with 0.3 probability, and a device with 120 Kmph speed occurs with 0.1 probability. As seen, embodiments herein may achieve a gain of around 8% in average sector throughput.

Some embodiments herein are applicable in a 5G network, e.g., in a New Radio (NR) network. For example, in some embodiments herein, the wireless communication network 10 is a massive MIMO network, e.g., with hundreds of antennas at the transmitter side and receiver side.

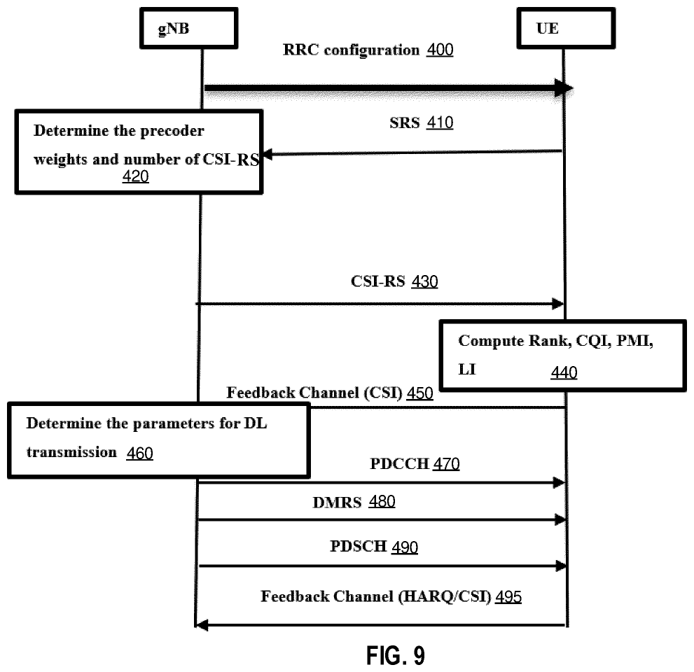

FIG. 9 shows the message sequence diagram for embodiments where the wireless communication network 10 is a reciprocity-based MIMO network, with the network node 14 exemplified as a gNB and the wireless communication device 12 exemplified as a user equipment (UE). The gNB configures the UE with an RRC configuration 400 before the actual data transmission. The RRC configuration 400 exemplifies the signaling 16 herein for configuring the UE to send the SRS 18 as often as the gNB determines the UE is to send the SRS 18. The RRC configuration 400 for example includes the SRS periodicity. The RRC configuration 400 may also include the SRS resource configuration, Channel State Information (CSI) Reference Signal (RS) (CSI-RS) periodicity, CSI-RS resource configuration, CSI configuration, etc.

The UE transmits the sounding reference signal (SRS) 410 based on the configured SRS periodicity and resource configuration. The gNB computes the precoding weights based on the SRS (Block 420). Note that in reciprocity-based systems, even though the gNB can compute the channel quality, CSI received from the UE is still used, as the UE knows the interference from the other cells. Hence, the gNB transmits the CSI-RS 430 periodically. The UE computes the CSI which typically includes rank indication (RI), CQI, PMI and layer indicator (LI) (Block 440). The UE feeds back these parameters in the uplink control/shared channel 450.

Once the gNB receives these parameters, the gNB uses CQI, RI from the UE, and PMI computed at gNB using SRS, to schedule the UE (Block 460). The gNB then transmits scheduling information for the actual data transmission over the Physical Downlink Control Channel (PDCCH) 470. The gNB next transmits the actual data transmission in the Physical Downlink Channel (PDSCH) 490, along with a Demodulation Reference Signal (DMRS) 480 for coherent demodulation.

In some embodiments, the network node 14 performs precoding of the data transmission, e.g., the PDSCH transmission, to achieve beamforming gain. When the channel is not known, such as in a Frequency Division Duplex (FDD) network, the network node 14 obtains the precoding index from the wireless communication device 12, whereas in embodiments where the wireless communication network 10 is a TDD network, the uplink channel can be estimated at the network node 14 via the SRS. Due to reciprocity, the downlink channel is equal to the uplink channel, so the precoding matrix/vector can be obtained from the channel estimation at the network node 14.

In reciprocity-based precoding, mathematically, the received signal can be written as

$$Y = H W x + n$$

where H is the channel matrix between the transmitter antenna elements dimensions (Nᵣ×Nₜ), W is the digital precoding matrix of dimensions (Nₜ×R), x is the transmitted signal vector of size (R×1), and R is the transmission rank of the system. For reciprocity-based systems W=V, where V is computed from:

$$S V D ( H ) = {UDV}^{′}$$

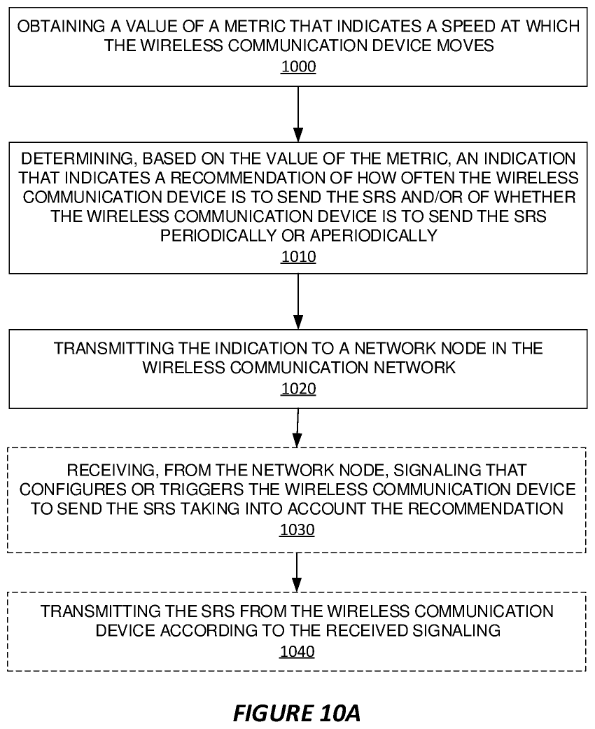

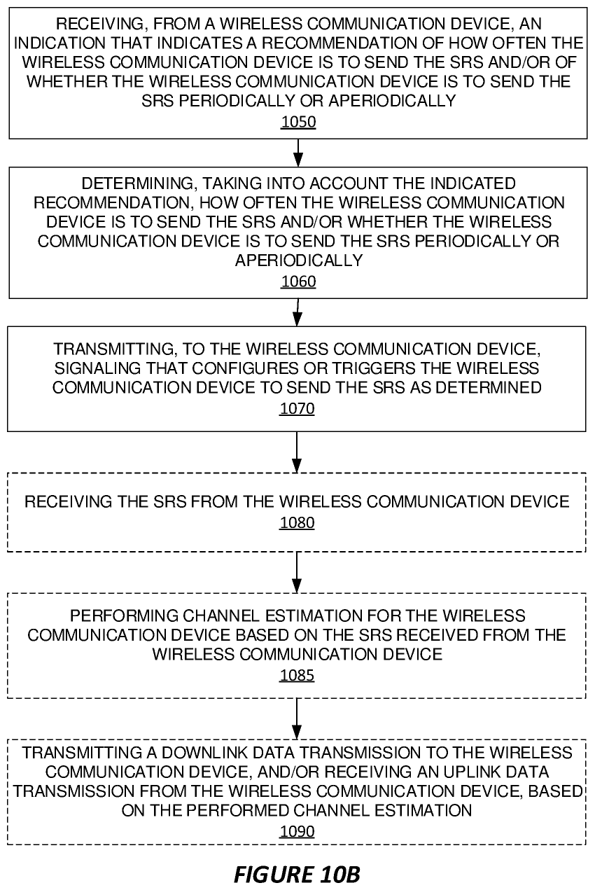

In view of the above modifications and variations, FIG. 10A depicts a method performed by a wireless communication device 12 configured for use in a wireless communication network 10 in accordance with particular embodiments. The method includes obtaining a value of a metric 22 that indicates a speed at which the wireless communication device 12 moves (Block 1000). The metric 22 may for example be a Doppler metric or may be the device's speed itself.

The method also comprises determining, based on the value of the metric 22, an indication 15 that indicates a recommendation of how often the wireless communication device 12 is to send the SRS 18 and/or of whether the wireless communication device 12 is to send the SRS 18 periodically or aperiodically (Block 1010). That is, the indicated recommendation may be a recommendation of how often the wireless communication device 12 is to send the SRS 18. Alternatively or additionally, the indicated recommendation may be a recommendation of whether the wireless communication device 12 is to send the SRS 18 periodically or aperiodically.

For example, in some embodiments, the indication 15 indicates a recommendation that the wireless communication device 12 is to send the SRS 18 more often for at least one value of the metric 22 below a threshold as compared to for at least one value above the threshold. The threshold may for example be exemplified by the threshold TH in FIG. 2A or FIG. 2B.

In any event, the method may then further comprise transmitting the indication 15 to a network node 14 in the wireless communication network 10 (Block 1020).

In some embodiments, the indication 15 indicates a recommendation that the wireless communication device 12 is to send the SRS 18 more often for values of the metric 22 below a threshold as compared to for values of the metric 22 above the threshold. In one embodiment, for example, the threshold is an upper threshold, a lower threshold is lower than the upper threshold, and the indication 15 indicates a recommendation that the wireless communication device 12 is to send the SRS 18 more often for values of the metric 22 between the lower threshold and the upper threshold as compared to for values of the metric 22 above the upper threshold. The indication 15 may for instance indicate a recommendation that the wireless communication device 12 is to send the SRS 18 more often for values of the metric 22 below the lower threshold as compared to for values of the metric 22 above the upper threshold. Alternatively or additionally, the indication 15 may indicate a recommendation that the wireless communication device 12 is to send the SRS 18 more often for values of the metric 22 between the lower threshold and the upper threshold as compared to for values of the metric 22 below the lower threshold.

In some embodiments, if the value of the metric 22 is below a threshold, the indication 15 indicates a recommendation that the wireless communication device 12 is to send the SRS 18 aperiodically and, if the value of the metric 22 is above the threshold, the indication 15 indicates a recommendation that the wireless communication device 12 is to send the SRS 18 periodically.

In some embodiments, if the value of the metric 22 is between a lower threshold and an upper threshold, the indication 15 indicates a recommendation that the wireless communication device 12 is to send the SRS 18 aperiodically. And, if the value of the metric 22 is below the lower threshold or above the upper threshold, the indication 15 indicates a recommendation that the wireless communication device 12 is to send the SRS 18 periodically.

In some embodiments, the metric 22 is a Doppler metric equal to v*f_{c}/C, where v is the speed of the wireless communication device 12, f_{c} is an uplink carrier frequency of the wireless communication device 12, and C is the speed of light in free space.

In some embodiments, the metric 22 is the speed of the wireless communication device 12.

In some embodiments, the method further comprises receiving, from the network node 14, signaling 16 that configures or triggers the wireless communication device 12 to send the SRS 18 taking into account the indicated recommendation (Block 1030). The method may also comprise transmitting the SRS 18 from the wireless communication device 12 according to the received signaling 16 (Block 1040).

In some embodiments, determining the indication 15 is based also on a power headroom of the wireless communication device 12.

In some embodiments, determining the indication 15 is based also on a remaining battery life of the wireless communication device 12.

As shown in FIG. 10B, embodiments herein also include a method performed by a network node 14 configured for use in a wireless communication network 10. The method comprises receiving, from a wireless communication device 12, a indication 15 that indicates a recommendation of how often the wireless communication device 12 is to send the SRS 18 and/or of whether the wireless communication device 12 is to send the SRS 18 periodically or aperiodically (Block 1050). The method also comprises determining, taking into account the indicated recommendation, how often the wireless communication device 12 is to send the SRS 18 and/or whether the wireless communication device 12 is to send the SRS 18 periodically or aperiodically (Block 1060). The method further comprises transmitting, to the wireless communication device 12, signaling 16 that configures or triggers the wireless communication device 12 to send the SRS 18 as determined (Block 1070).

In some embodiments, the determination in Block 1060 also takes into account a load of the network node 14 and/or a load of a cell serving the wireless communication device 12. For example, if the indicated recommendation recommends that the wireless communication device 12 is to send SRS very frequently, but the load of the network node 14 and/or the load of the serving cell is high, the network node 14 may configure or trigger the wireless communication device 12 to send SRS less frequently than recommended. However, if the load of the network node 14 and/or the load of the serving cell is low, the network node 14 may respect the indicated recommendation and configure or trigger the wireless communication device 12 to send SRS 18 as frequent as recommended.

In some embodiments, the method further comprises receiving 1030 the SRS 18 from the wireless communication device 12 (Block 1080). In one such embodiment, the method also comprises performing 1040 channel estimation for the wireless communication device 12 based on the SRS 18 received from the wireless communication device 12 (Block 1085), and transmitting 1050 a downlink data transmission to the wireless communication device 12, and/or receiving 1050 an uplink data transmission from the wireless communication device 12, based on the performed channel estimation (Block 1090). In this case, the downlink data transmission may be performed according to time division duplexing (TDD) operation and/or transmitting the downlink data transmission to the wireless communication device 12 based on the performed channel estimation may comprise precoding the downlink data channel transmission based on the performed channel estimation.

In other embodiments not shown, by contrast, such as may be the case if the network node 14 determines that the wireless communication device 12 is not to send the SRS 18 at all, the method may further comprise receiving codebook-based feedback from the wireless communication device 12, and precoding a downlink data channel transmission based on that feedback. Generally, then, in some embodiments, the method may alternatively or additionally comprise deciding whether to perform precoding of a downlink data channel transmission based on codebook-based feedback from the wireless communication device 12 or based on an estimate of an uplink channel over which SRS 18 is received from the wireless communication device 12, based on the recommendation 15.

Embodiments herein also include corresponding apparatuses. Embodiments herein for instance include a wireless communication device 12 configured to perform any of the steps of any of the embodiments described above for the wireless communication device 12.

Embodiments also include a wireless communication device 12 comprising processing circuitry and power supply circuitry. The processing circuitry is configured to perform any of the steps of any of the embodiments described above for the wireless communication device 12. The power supply circuitry is configured to supply power to the wireless communication device 12.

Embodiments further include a wireless communication device 12 comprising processing circuitry. The processing circuitry is configured to perform any of the steps of any of the embodiments described above for the wireless communication device 12. In some embodiments, the wireless communication device 12 further comprises communication circuitry.

Embodiments further include a wireless communication device 12 comprising processing circuitry and memory. The memory contains instructions executable by the processing circuitry whereby the wireless communication device 12 is configured to perform any of the steps of any of the embodiments described above for the wireless communication device 12.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the wireless communication device 12. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a network node 14 configured to perform any of the steps of any of the embodiments described above for the network node 14.

Embodiments also include a network node 14 comprising processing circuitry and power supply circuitry. The processing circuitry is configured to perform any of the steps of any of the embodiments described above for the network node 14. The power supply circuitry is configured to supply power to the network node 14.

Embodiments further include a network node 14 comprising processing circuitry. The processing circuitry is configured to perform any of the steps of any of the embodiments described above for the network node 14. In some embodiments, the network node 14 further comprises communication circuitry.

Embodiments further include a network node 14 comprising processing circuitry and memory. The memory contains instructions executable by the processing circuitry whereby the network node 14 is configured to perform any of the steps of any of the embodiments described above for the network node 14.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

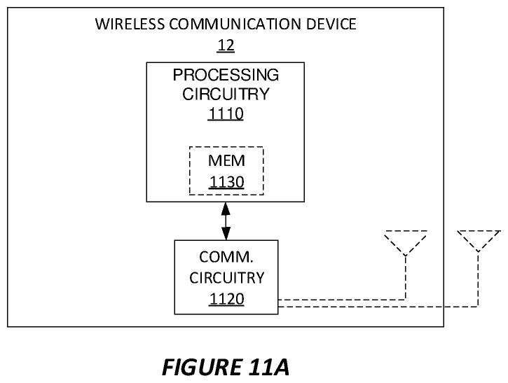

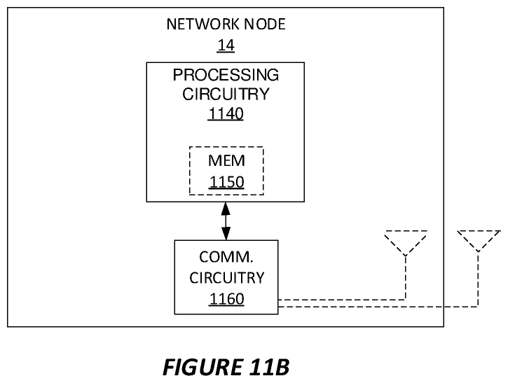

FIG. 11A for example illustrates a wireless communication device 12 as implemented in accordance with one or more embodiments. As shown, the wireless communication device 12 includes processing circuitry 1110 and communication circuitry 1120. The communication circuitry 1120 (e.g., radio circuitry) is configured to transmit and/or receive information to and/or from one or more other nodes, e.g., via any communication technology. Such communication may occur via one or more antennas that are either internal or external to the wireless communication device 1100. The processing circuitry 1110 is configured to perform processing described above, e.g., in FIG. 10A, such as by executing instructions stored in memory 1130. The processing circuitry 1110 in this regard may implement certain functional means, units, or modules.

FIG. 11B illustrates a network node 14 as implemented in accordance with one or more embodiments. As shown, the network node 14 includes processing circuitry 1140 and communication circuitry 1160. The communication circuitry 1160 (e.g., radio circuitry) is configured to transmit and/or receive information to and/or from one or more other nodes, e.g., via any communication technology. Such communication may occur via one or more antennas of the network node 14. The processing circuitry 1140 is configured to perform processing described above, e.g., in FIG. 10B, such as by executing instructions stored in memory 1150. The processing circuitry 1140 in this regard may implement certain functional means, units, or modules.

Those skilled in the art will also appreciate that embodiments herein further include corresponding computer programs.

A computer program comprises instructions which, when executed on at least one processor of a wireless communication device 12, cause the wireless communication device 12 to carry out any of the respective processing described above. A computer program in this regard may comprise one or more code modules corresponding to the means or units described above.

A computer program comprises instructions which, when executed on at least one processor of a network node 14, cause the network node 14 to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

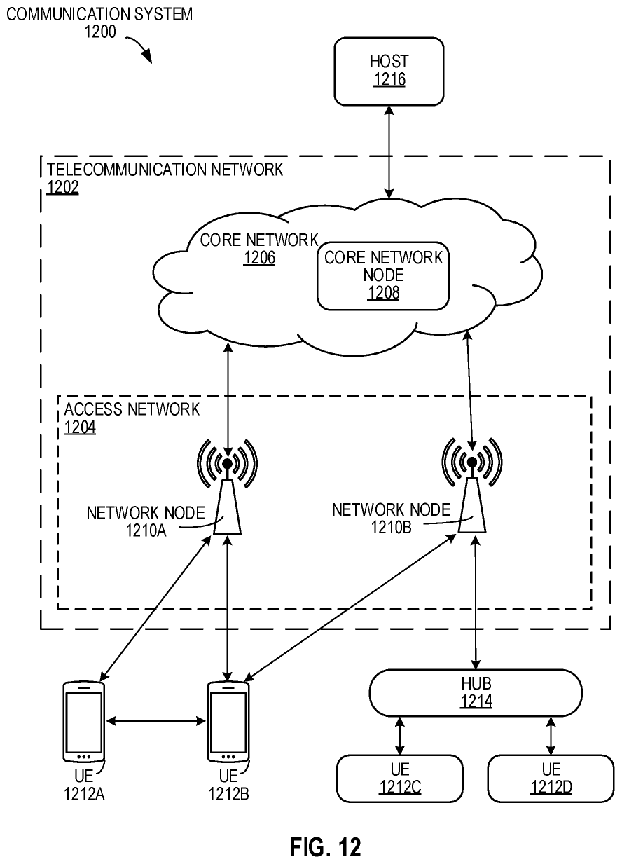

FIG. 12 shows an example of the wireless communication network 10, in the form of a communication system 1200 in accordance with some embodiments.

In the example, the communication system 1200 includes a telecommunication network 1202 that includes an access network 1204, such as a radio access network (RAN), and a core network 1206, which includes one or more core network nodes 1208. The access network 1204 includes one or more access network nodes, such as network nodes 1210a and 1210b (one or more of which may be generally referred to as network nodes 1210), or any other similar 3b Generation Partnership Project (3GPP) access node or non-3GPP access point. The network nodes 1210 facilitate direct or indirect connection of user equipment (UE), such as by connecting UEs 1212a, 1212b, 1212c, and 1212d (one or more of which may be generally referred to as UEs 1212) to the core network 1206 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1200 may include any number of wired or wireless networks, network nodes, UEs, and/or any other components or systems that may facilitate or participate in the communication of data and/or signals whether via wired or wireless connections. The communication system 1200 may include and/or interface with any type of communication, telecommunication, data, cellular, radio network, and/or other similar type of system.

The UEs 1212 may be any of a wide variety of communication devices, including wireless devices arranged, configured, and/or operable to communicate wirelessly with the network nodes 1210 and other communication devices. Similarly, the network nodes 1210 are arranged, capable, configured, and/or operable to communicate directly or indirectly with the UEs 1212 and/or with other network nodes or equipment in the telecommunication network 1202 to enable and/or provide network access, such as wireless network access, and/or to perform other functions, such as administration in the telecommunication network 1202.

In the depicted example, the core network 1206 connects the network nodes 1210 to one or more hosts, such as host 1216. These connections may be direct or indirect via one or more intermediary networks or devices. In other examples, network nodes may be directly coupled to hosts. The core network 1206 includes one more core network nodes (e.g., core network node 1208) that are structured with hardware and software components. Features of these components may be substantially similar to those described with respect to the UEs, network nodes, and/or hosts, such that the descriptions thereof are generally applicable to the corresponding components of the core network node 1208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1216 may be under the ownership or control of a service provider other than an operator or provider of the access network 1204 and/or the telecommunication network 1202, and may be operated by the service provider or on behalf of the service provider. The host 1216 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1200 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1202 is a cellular network that implements 3GPP standardized features. Accordingly, the telecommunications network 1202 may support network slicing to provide different logical networks to different devices that are connected to the telecommunication network 1202. For example, the telecommunications network 1202 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1212 are configured to transmit and/or receive information without direct human interaction. For instance, a UE may be designed to transmit information to the access network 1204 on a predetermined schedule, when triggered by an internal or external event, or in response to requests from the access network 1204. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1214 communicates with the access network 1204 to facilitate indirect communication between one or more UEs (e.g., UE 1212c and/or 1212d) and network nodes (e.g., network node 1210b). In some examples, the hub 1214 may be a controller, router, content source and analytics, or any of the other communication devices described herein regarding UEs. For example, the hub 1214 may be a broadband router enabling access to the core network 1206 for the UEs. As another example, the hub 1214 may be a controller that sends commands or instructions to one or more actuators in the UEs. Commands or instructions may be received from the UEs, network nodes 1210, or by executable code, script, process, or other instructions in the hub 1214. As another example, the hub 1214 may be a data collector that acts as temporary storage for UE data and, in some embodiments, may perform analysis or other processing of the data. As another example, the hub 1214 may be a content source. For example, for a UE that is a VR headset, display, loudspeaker or other media delivery device, the hub 1214 may retrieve VR assets, video, audio, or other media or data related to sensory information via a network node, which the hub 1214 then provides to the UE either directly, after performing local processing, and/or after adding additional local content. In still another example, the hub 1214 acts as a proxy server or orchestrator for the UEs, in particular in if one or more of the UEs are low energy IoT devices.

The hub 1214 may have a constant/persistent or intermittent connection to the network node 1210b. The hub 1214 may also allow for a different communication scheme and/or schedule between the hub 1214 and UEs (e.g., UE 1212c and/or 1212d), and between the hub 1214 and the core network 1206. In other examples, the hub 1214 is connected to the core network 1206 and/or one or more UEs via a wired connection. Moreover, the hub 1214 may be configured to connect to an M2M service provider over the access network 1204 and/or to another UE over a direct connection. In some scenarios, UEs may establish a wireless connection with the network nodes 1210 while still connected via the hub 1214 via a wired or wireless connection. In some embodiments, the hub 1214 may be a dedicated hub—that is, a hub whose primary function is to route communications to/from the UEs from/to the network node 1210b. In other embodiments, the hub 1214 may be a non-dedicated hub—that is, a device which is capable of operating to route communications between the UEs and network node 1210b, but which is additionally capable of operating as a communication start and/or end point for certain data channels.

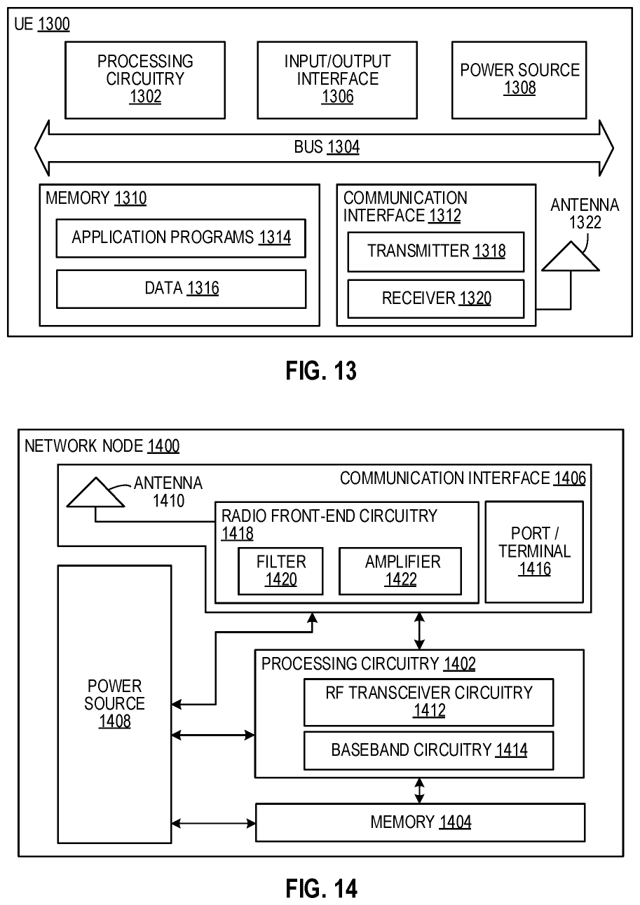

FIG. 13 shows a UE 1300 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band Internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1300 includes processing circuitry 1302 that is operatively coupled via a bus 1304 to an input/output interface 1306, a power source 1308, a memory 1310, a communication interface 1312, and/or any other component, or any combination thereof. Certain UEs may utilize all or a subset of the components shown in FIG. 13. The level of integration between the components may vary from one UE to another UE. Further, certain UEs may contain multiple instances of a component, such as multiple processors, memories, transceivers, transmitters, receivers, etc.

The processing circuitry 1302 is configured to process instructions and data and may be configured to implement any sequential state machine operative to execute instructions stored as machine-readable computer programs in the memory 1310. The processing circuitry 1302 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1302 may include multiple central processing units (CPUs).

In the example, the input/output interface 1306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1300. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1308 is structured as a battery or battery pack. Other types of power sources, such as an external power source (e.g., an electricity outlet), photovoltaic device, or power cell, may be used. The power source 1308 may further include power circuitry for delivering power from the power source 1308 itself, and/or an external power source, to the various parts of the UE 1300 via input circuitry or an interface such as an electrical power cable. Delivering power may be, for example, for charging of the power source 1308. Power circuitry may perform any formatting, converting, or other modification to the power from the power source 1308 to make the power suitable for the respective components of the UE 1300 to which power is supplied.

The memory 1310 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1310 includes one or more application programs 1314, such as an operating system, web browser application, a widget, gadget engine, or other application, and corresponding data 1316. The memory 1310 may store, for use by the UE 1300, any of a variety of various operating systems or combinations of operating systems.

The memory 1310 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1310 may allow the UE 1300 to access instructions, application programs and the like, stored on transitory or non-transitory memory media, to off-load data, or to upload data. An article of manufacture, such as one utilizing a communication system may be tangibly embodied as or in the memory 1310, which may be or comprise a device-readable storage medium.

The processing circuitry 1302 may be configured to communicate with an access network or other network using the communication interface 1312. The communication interface 1312 may comprise one or more communication subsystems and may include or be communicatively coupled to an antenna 1322. The communication interface 1312 may include one or more transceivers used to communicate, such as by communicating with one or more remote transceivers of another device capable of wireless communication (e.g., another UE or a network node in an access network). Each transceiver may include a transmitter 1318 and/or a receiver 1320 appropriate to provide network communications (e.g., optical, electrical, frequency allocations, and so forth). Moreover, the transmitter 1318 and receiver 1320 may be coupled to one or more antennas (e.g., antenna 1322) and may share circuit components, software or firmware, or alternatively be implemented separately.

In the illustrated embodiment, communication functions of the communication interface 1312 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1312, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1300 shown in FIG. 13.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 14 shows a network node 1400 in accordance with some embodiments, as an example of the network node 14 in FIG. 1. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1400 includes a processing circuitry 1402, a memory 1404, a communication interface 1406, and a power source 1408. The network node 1400 may be composed of multiple physically separate components (e.g., a NodeB component and a RNC component, or a BTS component and a BSC component, etc.), which may each have their own respective components. In certain scenarios in which the network node 1400 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1400 may be configured to support multiple radio access technologies (RATs). In such embodiments, some components may be duplicated (e.g., separate memory 1404 for different RATs) and some components may be reused (e.g., a same antenna 1410 may be shared by different RATs). The network node 1400 may also include multiple sets of the various illustrated components for different wireless technologies integrated into network node 1400, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1400.

The processing circuitry 1402 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1400 components, such as the memory 1404, to provide network node 1400 functionality.

In some embodiments, the processing circuitry 1402 includes a system on a chip (SOC). In some embodiments, the processing circuitry 1402 includes one or more of radio frequency (RF) transceiver circuitry 1412 and baseband processing circuitry 1414. In some embodiments, the radio frequency (RF) transceiver circuitry 1412 and the baseband processing circuitry 1414 may be on separate chips (or sets of chips), boards, or units, such as radio units and digital units. In alternative embodiments, part or all of RF transceiver circuitry 1412 and baseband processing circuitry 1414 may be on the same chip or set of chips, boards, or units.

The memory 1404 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1402. The memory 1404 may store any suitable instructions, data, or information, including a computer program, software, an application including one or more of logic, rules, code, tables, and/or other instructions capable of being executed by the processing circuitry 1402 and utilized by the network node 1400. The memory 1404 may be used to store any calculations made by the processing circuitry 1402 and/or any data received via the communication interface 1406. In some embodiments, the processing circuitry 1402 and memory 1404 is integrated.

The communication interface 1406 is used in wired or wireless communication of signaling and/or data between a network node, access network, and/or UE. As illustrated, the communication interface 1406 comprises port(s)/terminal(s) 1416 to send and receive data, for example to and from a network over a wired connection. The communication interface 1406 also includes radio front-end circuitry 1418 that may be coupled to, or in certain embodiments a part of, the antenna 1410. Radio front-end circuitry 1418 comprises filters 1420 and amplifiers 1422. The radio front-end circuitry 1418 may be connected to an antenna 1410 and processing circuitry 1402. The radio front-end circuitry may be configured to condition signals communicated between antenna 1410 and processing circuitry 1402. The radio front-end circuitry 1418 may receive digital data that is to be sent out to other network nodes or UEs via a wireless connection. The radio front-end circuitry 1418 may convert the digital data into a radio signal having the appropriate channel and bandwidth parameters using a combination of filters 1420 and/or amplifiers 1422. The radio signal may then be transmitted via the antenna 1410. Similarly, when receiving data, the antenna 1410 may collect radio signals which are then converted into digital data by the radio front-end circuitry 1418. The digital data may be passed to the processing circuitry 1402. In other embodiments, the communication interface may comprise different components and/or different combinations of components.

In certain alternative embodiments, the network node 1400 does not include separate radio front-end circuitry 1418, instead, the processing circuitry 1402 includes radio front-end circuitry and is connected to the antenna 1410. Similarly, in some embodiments, all or some of the RF transceiver circuitry 1412 is part of the communication interface 1406. In still other embodiments, the communication interface 1406 includes one or more ports or terminals 1416, the radio front-end circuitry 1418, and the RF transceiver circuitry 1412, as part of a radio unit (not shown), and the communication interface 1406 communicates with the baseband processing circuitry 1414, which is part of a digital unit (not shown).

The antenna 1410 may include one or more antennas, or antenna arrays, configured to send and/or receive wireless signals. The antenna 1410 may be coupled to the radio front-end circuitry 1418 and may be any type of antenna capable of transmitting and receiving data and/or signals wirelessly. In certain embodiments, the antenna 1410 is separate from the network node 1400 and connectable to the network node 1400 through an interface or port.

The antenna 1410, communication interface 1406, and/or the processing circuitry 1402 may be configured to perform any receiving operations and/or certain obtaining operations described herein as being performed by the network node. Any information, data and/or signals may be received from a UE, another network node and/or any other network equipment. Similarly, the antenna 1410, the communication interface 1406, and/or the processing circuitry 1402 may be configured to perform any transmitting operations described herein as being performed by the network node. Any information, data and/or signals may be transmitted to a UE, another network node and/or any other network equipment.

The power source 1408 provides power to the various components of network node 1400 in a form suitable for the respective components (e.g., at a voltage and current level needed for each respective component). The power source 1408 may further comprise, or be coupled to, power management circuitry to supply the components of the network node 1400 with power for performing the functionality described herein. For example, the network node 1400 may be connectable to an external power source (e.g., the power grid, an electricity outlet) via an input circuitry or interface such as an electrical cable, whereby the external power source supplies power to power circuitry of the power source 1408. As a further example, the power source 1408 may comprise a source of power in the form of a battery or battery pack which is connected to, or integrated in, power circuitry. The battery may provide backup power should the external power source fail.

Embodiments of the network node 1400 may include additional components beyond those shown in FIG. 14 for providing certain aspects of the network node's functionality, including any of the functionality described herein and/or any functionality necessary to support the subject matter described herein. For example, the network node 1400 may include user interface equipment to allow input of information into the network node 1400 and to allow output of information from the network node 1400. This may allow a user to perform diagnostic, maintenance, repair, and other administrative functions for the network node 1400.

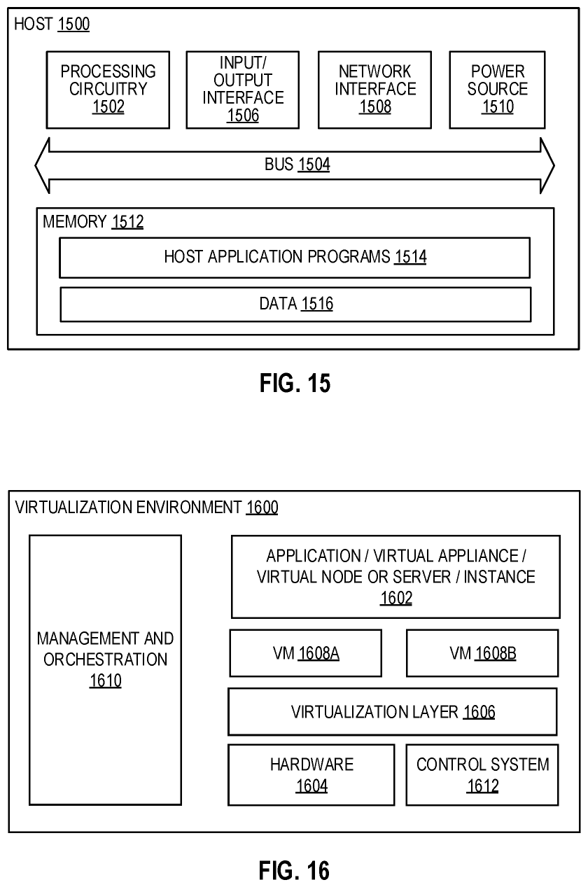

FIG. 15 is a block diagram of a host 1500, which may be an embodiment of the host 1216 of FIG. 12, in accordance with various aspects described herein. As used herein, the host 1500 may be or comprise various combinations hardware and/or software, including a standalone server, a blade server, a cloud-implemented server, a distributed server, a virtual machine, container, or processing resources in a server farm. The host 1500 may provide one or more services to one or more UEs.

The host 1500 includes processing circuitry 1502 that is operatively coupled via a bus 1504 to an input/output interface 1506, a network interface 1508, a power source 1510, and a memory 1512. Other components may be included in other embodiments. Features of these components may be substantially similar to those described with respect to the devices of previous figures, such as FIGS. 13 and 14, such that the descriptions thereof are generally applicable to the corresponding components of host 1500.

The memory 1512 may include one or more computer programs including one or more host application programs 1514 and data 1516, which may include user data, e.g., data generated by a UE for the host 1500 or data generated by the host 1500 for a UE. Embodiments of the host 1500 may utilize only a subset or all of the components shown. The host application programs 1514 may be implemented in a container-based architecture and may provide support for video codecs (e.g., Versatile Video Coding (WC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1514 may also provide for user authentication and licensing checks and may periodically report health, routes, and content availability to a central node, such as a device in or on the edge of a core network. Accordingly, the host 1500 may select and/or indicate a different host for over-the-top services for a UE. The host application programs 1514 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 16 is a block diagram illustrating a virtualization environment 1600 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1602 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1604 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1606 (also referred to as hypervisors or virtual machine monitors (VMMs)), provide VMs 1608a and 1608b (one or more of which may be generally referred to as VMs 1608), and/or perform any of the functions, features and/or benefits described in relation with some embodiments described herein. The virtualization layer 1606 may present a virtual operating platform that appears like networking hardware to the VMs 1608.

The VMs 1608 comprise virtual processing, virtual memory, virtual networking or interface and virtual storage, and may be run by a corresponding virtualization layer 1606. Different embodiments of the instance of a virtual appliance 1602 may be implemented on one or more of VMs 1608, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1608 may be a software implementation of a physical machine that runs programs as if they were executing on a physical, non-virtualized machine. Each of the VMs 1608, and that part of hardware 1604 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1608 on top of the hardware 1604 and corresponds to the application 1602.

Hardware 1604 may be implemented in a standalone network node with generic or specific components. Hardware 1604 may implement some functions via virtualization. Alternatively, hardware 1604 may be part of a larger cluster of hardware (e.g. such as in a data center or CPE) where many hardware nodes work together and are managed via management and orchestration 1610, which, among others, oversees lifecycle management of applications 1602. In some embodiments, hardware 1604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1612 which may alternatively be used for communication between hardware nodes and radio units.

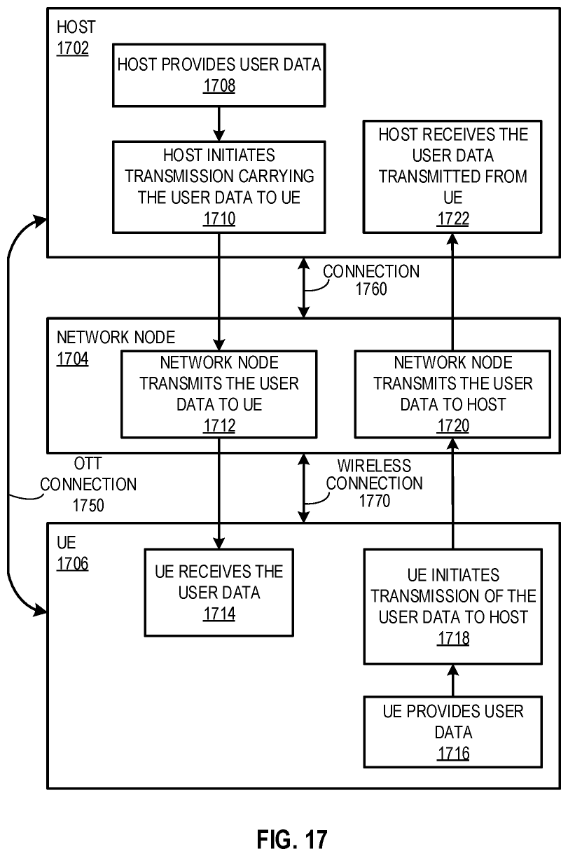

FIG. 17 shows a communication diagram of a host 1702 communicating via a network node 1704 with a UE 1706 over a partially wireless connection in accordance with some embodiments. Example implementations, in accordance with various embodiments, of the UE (such as a UE 1212a of FIG. 12 and/or UE 1300 of FIG. 13), network node (such as network node 1210a of FIG. 12 and/or network node 1400 of FIG. 14), and host (such as host 1216 of FIG. 12 and/or host 1500 of FIG. 15) discussed in the preceding paragraphs will now be described with reference to FIG. 17.

Like host 1500, embodiments of host 1702 include hardware, such as a communication interface, processing circuitry, and memory. The host 1702 also includes software, which is stored in or accessible by the host 1702 and executable by the processing circuitry. The software includes a host application that may be operable to provide a service to a remote user, such as the UE 1706 connecting via an over-the-top (OTT) connection 1750 extending between the UE 1706 and host 1702. In providing the service to the remote user, a host application may provide user data which is transmitted using the OTT connection 1750.

The network node 1704 includes hardware enabling it to communicate with the host 1702 and UE 1706. The connection 1760 may be direct or pass through a core network (like core network 1206 of FIG. 12) and/or one or more other intermediate networks, such as one or more public, private, or hosted networks. For example, an intermediate network may be a backbone network or the Internet.

The UE 1706 includes hardware and software, which is stored in or accessible by UE 1706 and executable by the UE's processing circuitry. The software includes a client application, such as a web browser or operator-specific “app” that may be operable to provide a service to a human or non-human user via UE 1706 with the support of the host 1702. In the host 1702, an executing host application may communicate with the executing client application via the OTT connection 1750 terminating at the UE 1706 and host 1702. In providing the service to the user, the UE's client application may receive request data from the host's host application and provide user data in response to the request data. The OTT connection 1750 may transfer both the request data and the user data. The UE's client application may interact with the user to generate the user data that it provides to the host application through the OTT connection 1750.

The OTT connection 1750 may extend via a connection 1760 between the host 1702 and the network node 1704 and via a wireless connection 1770 between the network node 1704 and the UE 1706 to provide the connection between the host 1702 and the UE 1706. The connection 1760 and wireless connection 1770, over which the OTT connection 1750 may be provided, have been drawn abstractly to illustrate the communication between the host 1702 and the UE 1706 via the network node 1704, without explicit reference to any intermediary devices and the precise routing of messages via these devices.

As an example of transmitting data via the OTT connection 1750, in step 1708, the host 1702 provides user data, which may be performed by executing a host application. In some embodiments, the user data is associated with a particular human user interacting with the UE 1706. In other embodiments, the user data is associated with a UE 1706 that shares data with the host 1702 without explicit human interaction. In step 1710, the host 1702 initiates a transmission carrying the user data towards the UE 1706. The host 1702 may initiate the transmission responsive to a request transmitted by the UE 1706. The request may be caused by human interaction with the UE 1706 or by operation of the client application executing on the UE 1706. The transmission may pass via the network node 1704, in accordance with the teachings of the embodiments described throughout this disclosure. Accordingly, in step 1712, the network node 1704 transmits to the UE 1706 the user data that was carried in the transmission that the host 1702 initiated, in accordance with the teachings of the embodiments described throughout this disclosure. In step 1714, the UE 1706 receives the user data carried in the transmission, which may be performed by a client application executed on the UE 1706 associated with the host application executed by the host 1702.

In some examples, the UE 1706 executes a client application which provides user data to the host 1702. The user data may be provided in reaction or response to the data received from the host 1702. Accordingly, in step 1716, the UE 1706 may provide user data, which may be performed by executing the client application. In providing the user data, the client application may further consider user input received from the user via an input/output interface of the UE 1706. Regardless of the specific manner in which the user data was provided, the UE 1706 initiates, in step 1718, transmission of the user data towards the host 1702 via the network node 1704. In step 1720, in accordance with the teachings of the embodiments described throughout this disclosure, the network node 1704 receives user data from the UE 1706 and initiates transmission of the received user data towards the host 1702. In step 1722, the host 1702 receives the user data carried in the transmission initiated by the UE 1706.

One or more of the various embodiments improve the performance of OTT services provided to the UE 1706 using the OTT connection 1750, in which the wireless connection 1770 forms the last segment.

In an example scenario, factory status information may be collected and analyzed by the host 1702. As another example, the host 1702 may process audio and video data which may have been retrieved from a UE for use in creating maps. As another example, the host 1702 may collect and analyze real-time data to assist in controlling vehicle congestion (e.g., controlling traffic lights). As another example, the host 1702 may store surveillance video uploaded by a UE. As another example, the host 1702 may store or control access to media content such as video, audio, VR or AR which it can broadcast, multicast or unicast to UEs. As other examples, the host 1702 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1750 between the host 1702 and UE 1706, in response to variations in the measurement results. The measurement procedure and/or the network functionality for reconfiguring the OTT connection may be implemented in software and hardware of the host 1702 and/or UE 1706. In some embodiments, sensors (not shown) may be deployed in or in association with other devices through which the OTT connection 1750 passes; the sensors may participate in the measurement procedure by supplying values of the monitored quantities exemplified above, or supplying values of other physical quantities from which software may compute or estimate the monitored quantities. The reconfiguring of the OTT connection 1750 may include message format, retransmission settings, preferred routing etc.; the reconfiguring need not directly alter the operation of the network node 1704. Such procedures and functionalities may be known and practiced in the art. In certain embodiments, measurements may involve proprietary UE signaling that facilitates measurements of throughput, propagation times, latency and the like, by the host 1702. The measurements may be implemented in that software causes messages to be transmitted, in particular empty or ‘dummy’ messages, using the OTT connection 1750 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally. Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1.-29. (canceled)

30. A method performed by a wireless communication device configured for use in a wireless communication network, the method comprising:
obtaining a value of a metric that indicates a speed at which the wireless communication device moves;
determining, based on the value of the metric, an indication that indicates a recommendation of how often the wireless communication device is to send a sounding reference signal (SRS) and/or of whether the wireless communication device is to send the SRS periodically or aperiodically; and
transmitting the indication to a network node in the wireless communication network.

31. The method of claim 30, wherein the indicated recommendation recommends that the wireless communication device is to send the SRS more often for values of the metric below a threshold as compared to for values of the metric above the threshold.

32. The method of claim 31, wherein the threshold is an upper threshold, wherein a lower threshold is lower than the upper threshold, and wherein the indicated recommendation recommends that the wireless communication device is to send the SRS more often for values of the metric between the lower threshold and the upper threshold as compared to for values of the metric above the upper threshold.

33. The method of claim 32, wherein the indicated recommendation recommends that the wireless communication device is to send the SRS more often for values of the metric below the lower threshold as compared to for values of the metric above the upper threshold.

34. The method of claim 32, wherein the indicated recommendation recommends that the wireless communication device is to send the SRS more often for values of the metric between the lower threshold and the upper threshold as compared to for values of the metric below the lower threshold.

35. The method of claim 30, wherein, if the value of the metric is below a threshold, the indicated recommendation recommends that the wireless communication device is to send the SRS aperiodically and, if the value of the metric is above the threshold, the indicated recommendation recommends that the wireless communication device is to send the SRS periodically.

36. The method of claim 30, wherein, if the value of the metric is between a lower threshold and an upper threshold, the indicated recommendation recommends that the wireless communication device is to send the SRS aperiodically and, if the value of the metric is below the lower threshold or above the upper threshold, the indicated recommendation recommends that the wireless communication device is to send the SRS periodically.

37. The method of claim 30, wherein the metric is a Doppler metric equal to v*f_{c}/C, where v is the speed of the wireless communication device, f_{C} is an uplink carrier frequency of the wireless communication device, and C is the speed of light in free space.

38. The method of claim 30, wherein the metric is the speed of the wireless communication device.

39. The method of claim 30, further comprising:
receiving, from the network node, signaling that configures or triggers the wireless communication device to send the SRS taking into account the indicated recommendation; and
transmitting the SRS from the wireless communication device according to the received signaling.

40. The method of claim 30, wherein determining the indication is based also on a power headroom of the wireless communication device.

41. The method of claim 30, wherein determining the indication is based also on a remaining battery life of the wireless communication device.

42. A method performed by a network node configured for use in a wireless communication network, the method comprising:
receiving, from a wireless communication device, an indication that indicates a recommendation of how often the wireless communication device is to send the SRS and/or of whether the wireless communication device is to send the SRS periodically or aperiodically;
determining, taking into account the indicated recommendation, how often the wireless communication device is to send the SRS and/or whether the wireless communication device is to send the SRS periodically or aperiodically; and
transmitting, to the wireless communication device, signaling that configures or triggers the wireless communication device to send the SRS as determined.

43. The method of claim 42, wherein said determining also takes into account a load of the network node and/or a load of a cell serving the wireless communication device.

44. The method of claim 42, further comprising receiving the SRS from the wireless communication device.

45. The method of claim 44, further comprising:
performing channel estimation for the wireless communication device based on the SRS received from the wireless communication device; and
transmitting a downlink data transmission to the wireless communication device, and/or receiving an uplink data transmission from the wireless communication device, based on the performed channel estimation.

46. The method of claim 45, wherein the downlink data transmission is performed according to time division duplexing (TDD) operation and/or wherein transmitting the downlink data transmission to the wireless communication device based on the performed channel estimation comprises precoding the downlink data channel transmission based on the performed channel estimation.

47. A wireless communication device configured for use in a wireless communication network, the wireless communication device comprising:
communication circuitry; and
processing circuitry configured to:
obtain a value of a metric that indicates a speed at which the wireless communication device moves;
determine, based on the value of the metric, an indication that indicates a recommendation of how often the wireless communication device is to send the SRS and/or of whether the wireless communication device is to send the SRS periodically or aperiodically; and
transmit the indication to a network node in the wireless communication network.

48. A network node configured for use in a wireless communication network, the network node comprising:
communication circuitry; and
processing circuitry configured to:
receive, from a wireless communication device, an indication that indicates a recommendation of how often the wireless communication device is to send the SRS and/or of whether the wireless communication device is to send the SRS periodically or aperiodically;
determine, taking into account the indicated recommendation, how often the wireless communication device is to send the SRS and/or whether the wireless communication device is to send the SRS periodically or aperiodically; and
transmit, to the wireless communication device, signaling that configures or triggers the wireless communication device to send the SRS as determined.

49. A system comprising a wireless communication device according to claim 47 and further comprising a network node, wherein the network node comprises:
communication circuitry; and
processing circuitry configured to:
receive, from the wireless communication device, an indication that indicates a recommendation of how often the wireless communication device is to send the SRS and/or of whether the wireless communication device is to send the SRS periodically or aperiodically;
determine, taking into account the indicated recommendation, how often the wireless communication device is to send the SRS and/or whether the wireless communication device is to send the SRS periodically or aperiodically; and
transmit, to the wireless communication device, signaling that configures or triggers the wireless communication device to send the SRS as determined.
